(19) United States
(12) Patent Application Publication
(10) Pub. No.: US 2021/0138410 A1
(43) Pub. Date: May 13, 2021

(54) MICROBUBBLE GENERATION DEVICE AND MICROBUBBLE GENERATION METHOD, AND SHOWER APPARATUS AND OIL-WATER SEPARATION APPARATUS HAVING SAID MICROBUBBLE GENERATION DEVICE

(71) Applicant: SIGMA-TECHNOLOGY INC., Hitachinaka-shi, Ibaraki (JP)

(72) Inventors: Yoshiaki TACHIBANA, Hitachinaka (JP); Kousuke TACHIBANA, Hitachinaka (JP); Souzou SASAJIMA, Hitachinaka (JP); Kyoko HONMA, Hitachinaka (JP)

(21) Appl. No.: 16/623,175

(22) PCT Filed: Aug. 2, 2017
(86) PCT No.: PCT/JP2017/027970

§ 371 Date: Dec. 16, 2019

(51) Int. Cl. B01F 5/00; B01F 3/04; C02F 1/24

(52) U.S. Cl. CPC B01F 5/0068; B01F 3/0446; C02F 2101/32; B01F 2003/04872; C02F 1/24

(57) ABSTRACT

Provided are: a microbubble generation device utilizing a swirling flow generated by injecting of a pressurized liquid; a microbubble generation method capable of generating a large amount of bubbles; and a shower apparatus and an oil-water separation apparatus having said microbubble generation device. This microbubble generation device comprises: a cylindrical or conical cylinder with a gas-liquid swirling chamber therein; a gas-liquid discharge inlet provided on one end of the cylindrical or conical cylinder; and a liquid supply cylinder and a gas supply cylinder for introducing a liquid and a gas into the gas-liquid swirling chamber. For the gas-liquid discharge outlet, a plurality of small cylindrical through-holes or a plurality of small recessed parts with a circular cross-section and at least a semicircular circumferential length, are respectively provided in the wall of a closed end at one end of the cylindrical or conical cylinder or on the circumferential surface of the inner wall of an open end at one end thereof.

### TECHNICAL FIELD

The present invention relates to a microbubble generation device used for a shower used in bathrooms, washrooms, etc., transportation and farming of aquatic organisms, purification of tap water, river water, ponds, lakes, dams, etc., resuscitation of the water environment, oil separation, etc. The present invention also relates to a microbubble generation method, and a shower apparatus and an oil-water separation apparatus having the microbubble generation device.

### BACKGROUND OF THE INVENTION

When hot water or water is discharged, the head and body are washed by creating a gentle flow from a shower head with a small hole using a shower in baths and bathrooms. It is known that cleaning with bubbles can improve the cleaning effect more than that without bubbles. When cleaning with the bubbles generated by the shower, it is expected that a cleaning efficiency will be increased, and that the skin massage effect and blood circulation will be improved. Air as well as hot water need to be taken in to generate bubbles. It is known that bubbles are generated by a method such as a venturi, and that showers with a venturi nozzle entering air from the side of a pipe are sold. A method of generating bubbles using a swirling flow generated by swirl holes is also applied to shower apparatus.

In addition, air floatation using a microbubble generation device has been well known as a method for transporting and farming aquatic organisms, purifying water quality such as tap water, river water, ponds, lakes, and dams, and reviving the water environment. Various methods different from those applied in the shower apparatus have been proposed as the microbubble generation device. For example, Patent Documents 1 to 4 disclose microbubble methods using a gas-liquid swirling flow.

The swirling microbubble generation device disclosed in Patent Document 1 comprises; a container having a conical or bottle-shaped space: a liquid inlet opened in a tangential direction on a part of the inner wall circumferential surface of the space: a gas introduction hole opened at the bottom of the space: and a swirling gas-liquid outlet opened at the top of the space. In this microbubble generation device, a swirling flow is generated inside and a negative pressure portion is formed on the conical tube axis by pumping a pressurized flow into the conical or bottle-shaped space from the liquid inlet. Microbubbles are obtained based on this mechanism.

Patent Document 2 discloses a microbubble generation device comprising; a container having a space in which a swirl flow can occur; a pressurized liquid inlet; a gas inlet; a liquid inlet; and a gas-liquid mixture outlet. The pressurized liquid inlet is arranged on a side surface of the container, so that the pressurized liquid that generates a swirling flow into the space is guided into the container.

Patent Document 3 proposes a gas-liquid mixer in which a swirling flow of water is formed by introducing water from a water conduit in the tangential direction of the liquid chamber of the mixing cylinder, microbubbles are generated by sucking a gas from an air supply pipe provided on the back surface and mixing the gas with the swirling flow of water, and the microbubbles are changed into ultrafine bubbles with a filter member which is provided outside the opening to perform bubble miniaturization.

Patent Document 4 discloses a swirling microbubble generation device comprising: a preliminary swirling unit that rectifies a gas-liquid mixture swirled by a liquid introduced from a liquid outlet in order to suppress the occurrence of severe cavitation erosion in the gas-liquid swirling chamber; and a main swirling section that contacts a gas introduced from a gas inlet with the liquid rectified in the preliminary swirling unit.

On the other hand, an application of the fine bubble generation device to an oil-water separation apparatus using a floating separation method has been studied. For example, Patent Documents 5 to 7 have proposed various configurations and structures.

In these oil-water separation apparatus according to the prior arts, unlike the swirling microbubble generator, a microbubble generation device that refines bubbles from an air blower with an impeller or a propeller blade (Patent Document 5), a microbubble generating device that treats dissolved air under a reduced pressure in a remover of large bubbles to obtain microbubbles (Patent Document 6), and a microbubble generation device that moves by pressurization and depressurization (Patent Document 7) are used, respectively.

### RELATED ART

### Patent Literature

[Patent Document 1] Japanese Unexamined Patent Application Publication No. 2000-447

[Patent Document 2] Japanese Unexamined Patent Application Publication No. 2007-111616

[Patent Document 3] Japanese Unexamined Patent Application Publication No. 2004-195393

[Patent Document 4] Japanese Unexamined Patent Application Publication No. 2006-142300

[Patent Document 5] Japanese Unexamined Patent Application Publication No. 03-229696

[Patent Document 6] Japanese Unexamined Patent Application Publication No. 2005-125167

[Patent Document 7] Japanese Unexamined Patent Application Publication No. 2014-151318

### SUMMARY OF THE INVENTION

### Problems to be solved by the Invention

As a microbubble generation device that can be used for applications such as a shower used in bathrooms and washrooms, transport and storage of aquatic organisms, water purification and water environment resuscitation, and oil-water separation, it is traditionally required that bubbles can be miniaturized, that a large amount of fine bubbles can be generated efficiently, and that the generation of fine bubbles can be maintained even during a long time operation. Furthermore, a simple and compact configuration and structure thereof are strongly desired from the viewpoints of operability, durability, maintainability, and manufacturing cost reduction.

The venturi system in which the gas is put from a hole formed in the side of the tube when mixing a liquid and the gas, may cause water to enter the gas inlet when handling the shower by hand, thereby preventing the inflow of gas to the gas inlet. Therefore, the venturi-type shower has a problem that its operability and handling ability are inferior.

Further, the swirl type fine bubble generator described in Patent Documents 1 to 3 can generate fine bubbles with a simple mechanism of generating a swirl flow using a pressurized liquid. Because the swirl type fine bubble generator employed a method of pumping the pressurized liquid from an inlet formed in the tangential direction or side surface of the container, it is required to increase the pressure of the liquid introduced under pressure in order to generate a large amount of microbubbles. However, when the pressure of the liquid to be introduced under pressure is increased, a cavitation erosion occurs, resulting in a problem that the apparatus is worn and broken in a short period of time. This problem has been also pointed out in Patent Document 4.

Furthermore, in the microbubble generation devices described in Patent Documents 1 to 3, various devices are installed on the discharge port side of the gas-liquid mixture in order to generate microbubbles having a small diameter. However, these microbubble generation devices hardly generate a large amount of fine bubbles, and in the case of generating a large amount, the configuration and structure on the discharge port side of the gas-liquid mixture are complicated. For example, the invention described in Patent Document 1 adopts a method of reducing the cross section of a space from a pressurized liquid inlet to a swirling gas-liquid outlet, and a method of directing a swirling flow from four central outlets to four side outlets, respectively. However, the former has a limit in generating a large amount of fine bubbles, and the latter requires a rather large apparatus due to its complicated structure. In addition, the invention described in Patent Document 2 discloses a method of providing a plurality of gas-liquid mixture discharge ports, or a method of discharging a gas-liquid mixture through a gap from the side by providing with another donut-type bottom surface arranged with the gap from the end of the side surface of the container, respectively. However, in the former having a configuration in which the gas-liquid mixture is only discharged from the swirling tangential direction, the bubbles of the discharged gas-liquid mixture tend to have a larger particle diameter. The latter has a complicated apparatus and structure. Furthermore, the invention described in Patent Document 3 hardly generate a large amount of fine bubbles due to a resistance easily received from a filter member used as the bubble refining means when discharging a gas-liquid mixture. Therefore, from the standpoints of installation and handling, a device that is simpler and excellent in versatility is required as a device capable of generating a large amount of microbubbles having a small particle size.

The microbubble generation device described in Patent Document 4 has been proposed to suppress the cavitation erosion. However, it is necessary to increase the length of a casing by a portion corresponding to the preliminary swirling unit, since the microbubble generation device has the gas-liquid swirling chamber comprising the preliminary swirling unit and the main swirling unit. Furthermore, a gas inlet for introducing gas into the gas-liquid swirl chamber is provided extending to near the boundary between the preliminary swirl portion and the main swirl portion. This causes the microbubble generation device to have a rather complicated configuration and structure. Furthermore, the microbubble generation device comprises a through-hole with a small diameter as a gas-liquid discharge port transferred to the center of the edge part wall surface of a casing, but this structure hardly generates a large amount of fine bubbles and there is a limitation in doing so.

On the other hand, the oil-water separation apparatus described in Patent Documents 5 to 7 need to have parts and devices specially designed to produce a large amount of microbubbles and improve durability thereof, such as an impeller, a large bubble remover, and a pressure and decompression type fine bubble generator. However, it was not satisfactory in terms of handling and operability, since the configuration thereof was somewhat complicated. Therefore, there is a strong demand for an oil-water separation apparatus having a highly versatile microbubble generation device that can be handled more easily and has an excellent operability and durability.

The present inventions have been made in view of the above-described conventional problems. An object of the present invention is to provide a compact microbubble generation device which can generate a large amount of microbubbles by a simple mechanism of generating a swirling flow created by injecting a pressurized liquid in order to obtain the device which is excellent in handling, operability and durability by adopting a simpler configuration and structure, as compared with the conventional devices, and a method for generating a large amount of microbubbles by such the microbubble generation device. Another object of the present inventions is to provide with a shower apparatus and an oil and water separation apparatus having an excellent operability and durability, and a high versatility by using the swirling type microbubble generation device having such characteristics.

### Means for Solving the Problems

In microbubble generation devices using gas-liquid swirling flow, the present invention has been achieved with the discovery that the above-described challenge can be solved by adopting a new structure on a discharge side of a gas-liquid mixture to generate a large amount of microbubbles with a smaller particle size, and furthermore by adopting a structure of an inner cylinder comprising: through-slits or a through-holes formed so that a pressurized liquid is injected from the outside to the inside of the inner cylinder to generate a gas-liquid swirling flow; an inlet for introducing a gas into the inner cylinder; and an opening end portion capable of acting as a gas-liquid discharge outlet through which a gas-liquid discharges from a gas-liquid swirling chamber, as well as a structure of the inner cylinder comprising: the gas-liquid swirling chamber; and an outer cylinder container which forms a double cylinder structure by inserting the inner cylinder inside, differing from the swirling type microbubble generation device described in Patent Document 4.

That is, the configuration of the present invention is as follows.

[1] The present invention provides a microbubble generation device comprising: a cylindrical or conical cylinder having a gas-liquid swirling chamber therein for creating a space where a gas-liquid can swirl;

a gas-liquid discharge outlet formed on one side of the cylindrical or conical cylinder for discharging a gas-liquid mixture obtained by mixing a gas and a liquid in the gas-liquid swirling chamber; a liquid supply cylinder having a liquid inlet for introducing the liquid into the gas-liquid swirling chamber; and the gas supply cylinder having a gas inlet for introducing the gas into the gas-liquid swirling chamber,

wherein the gas-liquid discharge outlet has a plurality of through-holes or small recessed parts for branching and changing a large swirling vortex formed by the gas-liquid swirling chamber into smaller swirling vortexes on a liquid discharge side of the cylindrical or conical cylinder having a gas-liquid swirling chamber therein,

wherein the through-holes have a cylindrical shape and a small cross sectional circle diameter, being formed as the gas-liquid discharge outlet on an end wall surface closed on one side of the cylindrical or conical cylinder having the gas-liquid swirling chamber therein,

wherein the small recessed parts have a circular cross section and a circumferential length of a semicircle or more, being formed from the gas-liquid discharge outlet to the middle along a longitudinal direction of the inner wall of the cylindrical or conical cylinder toward the inside of the cylindrical or conical cylinder on the circumferential surface of the end inner wall opened at one side of the cylindrical or conical cylinder having the gas-liquid swirling chamber.

[2] The present invention provides the microbubble generation device according to the preceding [1],

wherein a circular diameter of a circular cross-sectional shape of the cylindrical through-holes or the small recessed parts is less than a half of the inner wall cross-sectional diameter of the cylindrical or conical cylinder having the gas-liquid swirling chamber therein, and has 10 mm or less as the absolute value.

[3] The present invention provides the microbubble generation device according to the preceding [1] or [2],

wherein each of the plurality of cylindrical through-holes has the same diameter in the circular cross-sectional shape, and is formed point-symmetrically with respect to a center of an end wall surface that is closed on one side of the cylindrical or conical cylinder having the gas-liquid swirling chamber therein.

[4] The present invention provides the microbubble generation device according to the preceding [1] or [2],

wherein each of the plurality of small recessed parts has the same diameter in the circular cross sectional shape, and is formed continuously in the state adjacent to each other on the circumferential surface of the inner wall of one end of the cylindrical or conical cylinder having the gas-liquid swirling chamber therein.

[5] The present invention provides the microbubble generation device according to any of the preceding [1] to [4], the device comprising:

an inner cylinder composed of the cylindrical or conical cylinder having the gas-liquid swirling chamber therein for creating the space where the gas-liquid can swirl; a cylindrical or conical outer cylinder container that forms a double cylindrical structure together with the inner cylinder inserted therein; and the liquid supply cylinder having the liquid inlet for introducing the liquid into the outer cylinder container,

wherein the inner cylinder comprises: an end closed at the liquid supply cylinder side; an end opposite to the liquid supply cylinder side, which has an opening for introducing the gas, provided as the gas inlet for introducing gas into the gas-liquid swirling chamber, and the plurality of cylindrical through-holes or the plurality of small recessed parts with a circular cross section and a circumferential length of a semicircle or more, provided as the gas-liquid discharge outlet for discharging the gas-liquid from the gas-liquid swirling chamber, wherein the small recessed parts are formed up to the middle along the longitudinal direction of the inner wall of the cylindrical or conical cylinder from the gas-liquid discharge outlet toward the inside of the cylindrical or conical cylinder on the circumferential surface of the end inner wall opened at one side opposite to the liquid supply cylinder side; and one or more through-slits or through-holes that are formed from one end on the liquid supply cylinder side to the middle along a longitudinal direction of the inner cylinder,

wherein the inner cylinder is integrated with the outer cylinder container in such a way that a gap for introducing the liquid is formed between the inner cylinder outer wall of the part where the through-slits or the through-holes are formed and the inner wall of the outer cylinder container, and

wherein microbubbles are generated using the gas-liquid swirling flow created by injecting and introducing the liquid which is supplied through the through-slits or through-holes from the liquid introduction inlet of the liquid supply cylinder into the gas-liquid swirling chamber equipped inside the inner cylinder.

[6] The present invention provides the microbubble generation device according to any of the preceding [1] to [4], the device comprising:

an inner cylinder composed of the cylindrical or conical cylinder having the gas-liquid swirling chamber therein for creating the space where the gas-liquid can swirl; the cylindrical or conical outer cylinder container that forms a double cylindrical structure together with the inner cylinder inserted therein; and the liquid supply cylinder having the liquid inlet for introducing liquid into the outer cylinder container,

wherein the inner cylinder comprises: an opening end connected to the gas supply cylinder having a gas inlet on the liquid supply cylinder side, provided as the gas inlet for introducing gas into the gas-liquid swirling chamber; an end opposite to the liquid supply cylinder side, which has a plurality of cylindrical through-holes on the circumferential surface of the end inner wall closed thereat, or a plurality of small recessed parts with a circular cross section and a circumferential length of a semicircle or more on the circumferential surface of the end inner wall opened thereat, provided as the gas-liquid discharge outlet for discharging gas-liquid from the gas-liquid swirling chamber, wherein the small recessed parts are formed up to the middle along the longitudinal direction of the inner wall of the cylinder from the gas-liquid discharge outlet toward the inside of the cylindrical or conical cylinder; and one or more through-slits or through-holes that are formed from one end on the liquid supply cylinder side to the middle along a longitudinal direction of the inner cylinder,

wherein the inner cylinder is integrated with the outer cylinder container in such a way that a gap for introducing the liquid is formed between the inner cylinder outer wall of the part where the through-slits or through-holes are formed and the inner wall of the outer cylinder container, and

wherein microbubbles are generated using the gas-liquid swirling flow created by injecting and introducing the liquid which is supplied through the through-slits or the through-holes from the liquid introduction inlet of the liquid supply cylinder into the gas-liquid swirling chamber equipped inside the inner cylinder.

[7] The present invention provides the microbubble generation device according to any of the preceding [1] to [4], the device comprising:

an inner cylinder composed of the cylindrical or conical cylinder having the gas-liquid swirling chamber therein for creating the space where the gas-liquid can swirl; a cylindrical or conical outer cylinder container that forms a double cylindrical structure together with the inner cylinder inserted therein; and the liquid supply cylinder having the liquid inlet for introducing liquid into the outer cylinder container,

wherein the inner cylinder comprises: an opening end connected to the gas supply cylinder having a gas inlet on the liquid supply cylinder side, provided as the gas inlet for introducing gas into the gas-liquid swirling chamber; an end opposite to the liquid supply cylinder side, which has a plurality of cylindrical through-holes on the circumferential surface of the end inner wall closed thereat, or a plurality of small recessed parts with a circular cross section and a circumferential length of a semicircle or more on the circumferential surface of the end inner wall opened thereat, provided as the gas-liquid discharge outlet for discharging the gas-liquid from the gas-liquid swirling chamber, wherein the small recessed parts are formed up to the middle along the longitudinal direction of the inner wall of the cylinder from the gas-liquid discharge outlet toward the inside of the cylindrical or conical cylinder; and one or more through-slits or through-holes that are formed from one end on the liquid supply cylinder side to the middle along a longitudinal direction of the inner cylinder,

wherein the inner cylinder is integrated with the outer cylinder container in such a way that a gap for introducing the liquid is formed between the inner cylinder outer wall of the part where the through-slits or the through-holes are formed and the inner wall of the outer cylinder container, and

wherein microbubbles are generated using the gas-liquid swirling flow created by injecting and introducing the liquid which is supplied through the through-slits or through-holes from the liquid introduction inlet of the liquid supply cylinder into the gas-liquid swirling chamber equipped inside the inner cylinder.

[8] The present invention provides the microbubble generation device, according to any of the preceding [5] to [7],

wherein the through-slits or the through-holes have an opening passage adjusting a jetting direction so that a position of P is included in a distance range of r/2 or less toward the center from the inner wall of the inner cylinder section on the vertical line, when an inner wall circular radius of the inner cylinder cross section is r, and a position of the inner wall section of the inner cylinder cross section where the injected liquid collides is P, wherein P is the position projected onto a line drawn with respect to the tangent line of the inner wall circle parallel to the liquid injection direction.

[9] The present invention provides the microbubble generation device according to any of the preceding [5] to [8],

wherein the through-holes are arranged in a longitudinal direction of the inner cylinder, and

wherein L is larger than W, when a length of the through-slits or a distance between the centers of the through-holes positioned at both ends, arranged in the longitudinal direction of the inner cylinder, is L, and a width of the through-slits in the direction perpendicular to the longitudinal direction of the inner cylinder, or a diameter or a length of the through-holes is W.

[10] The present invention provides the microbubble generation device according to any of the preceding [5] or [9],

wherein the plurality of through-slits or through-holes are formed at equal intervals in the circumferential direction of the inner cylinder cross-section.

[11] The present invention provides the microbubble generation device according to any of the preceding [5] or [7],

wherein the microbubble generation device has a cylindrical tube for introducing the gas into the inner cylinder having the gas-liquid swirling chamber, being configured one end of the cylindrical tube to be the gas inlet.

[12] The present invention provides a microbubble generation method using the microbubble generation device defined in any of the preceding [5] to [11], the method comprising:

injecting and introducing a pressurized liquid supplied through the through-slits or through-holes formed in the inner cylinder from the liquid inlet of the liquid supply cylinder into the gas-liquid swirling chamber inside the cylinder by supplying a pressurized liquid from the liquid inlet of the liquid supply cylinder;

mixing the gas sucked from the gas inlet under a negative pressure generated at the center of the swirling flow of the liquid that is formed by a centrifugal force created when the liquid jet is introduced into the gas-liquid swirling chamber, with the liquid injected from a liquid injection port of the through-slits or the through-holes at the liquid injection port and in the vicinity thereof; and

discharging the gas-liquid swirling flow obtained by mixing of the liquid and the gas through the inner wall surface of the inner cylinder from the gas-liquid discharge outlet.

[13] The present invention provides the microbubble generation method in a state of immersing the microbubble generation device defined in the preceding [11] into a liquid, the method comprising:

injecting and introducing a pressurized liquid supplied through the through-slits or the through-holes formed in the inner cylinder from the liquid inlet of the liquid supply cylinder into the gas-liquid swirling chamber equipped inside the inner cylinder;

introducing the gas through the cylindrical tube from the outside into the gas-liquid swirling chamber equipped inside the inner cylinder; mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through-slits or the through-holes at the liquid injection port and in the vicinity thereof; and

discharging the gas-liquid swirling flow obtained by mixing of the liquid through the inner wall surface of the inner cylinder from the gas-liquid discharge outlet.

[14] The present invention provides the microbubble generation method in a state of immersing the microbubble generation device defined in the preceding [11] into a liquid, the method comprising:

injecting and introducing a pressurized liquid supplied from the liquid inlet of the liquid supply cylinder through the through-slits or through-holes formed in the inner cylinder into the gas-liquid swirling chamber inside the cylinder tube;

introducing a warm air with a higher temperature or a cool air with a lower temperature than the liquid before immersion of the microbubble generating device through the cylindrical tube from the outside into the gas-liquid swirling chamber equipped inside the inner cylinder;

mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through slits or the through holes at the liquid injection port and in the vicinity thereof; and

discharging the gas-liquid swirling flow obtained by mixing of the liquid through the inner wall surface of the inner cylinder from the gas-liquid discharge outlet,

wherein a temperature in the liquid having the microbubble generation device immersed therein is adjusted by the warm air or the cool air.

[15] The present invention provides a shower apparatus comprising the microbubble generating device defined in any of the preceding [1] to [11],

wherein a water or a hot water is supplied from an opening located on the side opposite to the liquid introduction inlet in the liquid supply cylinder, and sprayed from the gas-liquid discharging outlet of the microbubble generation device in a state of containing microbubbles.

[16] The present invention provides an oil-water separation apparatus comprising:

the microbubble generating device defined in claim 11 arranged at a bottom of the oil-water separator;

an oil and water mixture separation tank for injecting an oil and water mixture; and

a pump for supplying or circulating a part of the oil and water mixture injected into the oil and water mixture separation tank to the liquid supply cylinder equipped in the microbubble generation device.

### Advantageous Effects of the Invention

The microbubble generation device according to the present invention can miniaturize the bubbles, generate a large amount of fine bubbles efficiently, and maintain the generation of the fine bubbles even during long-time operation by not only generating microbubbles by a simple mechanism of generating a swirling flow by the injection of pressurized liquid, but also having the gas-liquid discharge outlet in which a plurality of through-holes or small recessed parts having a small vortex branching function for changing a large swirl vortex into small vortexes are formed on the gas-liquid discharge side of the cylindrical or conical cylinder having a gas-liquid swirling chamber inside. In addition, the microbubble generation device is excellent in handling, operability and durability, and can construct a compact device, due to its simpler configuration and structure than the conventional microbubble generation device utilizing the swirling flow.

Unlike the venturi system, the microbubble generation device according to the present invention does not have a gas injection tube etc. on the side surface of the outer cylinder container and has a simple structure, resulting in an excellent operability and handling. Furthermore, by using the microbubble generation device according to the present invention, it is possible to establish the microbubble generation method by which a large amount of stable microbubbles can be generated efficiently over a long period of time. Therefore, not only a high cleaning efficiency but also an effect of improving the skin massaging effect and the blood circulation can be obtained, when the microbubble generation device according to the present invention is applied to the shower apparatus. In addition, the microbubbles generation device according to the present invention contributes greatly to the maintenance and growth of living organisms and environmental conservation, when applied to the transportation and farming of living organisms, water purification, tap water, river water, ponds, lakes, dams, etc. for water quality purification and resuscitation of the water environment,.

On the other hand, when the swirl flow microbubble generation device of the present invention is applied as the component of the oil and water separation apparatus, the configuration and structure thereof become simple, resulting in an excellent operability and durability and high versatility. In addition, it is possible to reduce costs for manufacturing, installation, and maintenance as compared with conventional oil-water separation apparatus, since an efficient oil-water separation performance is maintained over a long period of time.

### BRIEF DESCRIPTION OF DRAWINGS

FIGS. 1A and 1B illustrate respectively a cross sectional view and a bottom view, which show an example of the microbubble generating device according to the present invention in which a gas-liquid discharge port has a new configuration and structure based on the conventional microbubble generator.

FIGS. 2A, 2B and 2C are respectively a sectional view, a bottom view and an enlarged bottom view, which show another example of the microbubble generating device according to the present invention in which a gas-liquid discharge port has a new configuration and structure based on the conventional microbubble generator.

FIGS. 3A and 3B illustrate a plan view and a front view, respectively, which show an example of a microbubble generation device having a double cylindrical structure according to the present invention.

FIG. 4 is a diagram showing the cross section of C-C position, the flow of liquid and gas, and a mixing state thereof for the microbubble generation device shown in FIGS. 3A and 3B.

FIG. 5 is a cross sectional view taken along the D-D line of the microbubble generation device shown in FIGS. 3A and 3B.

FIG. 6 is a schematic diagram showing a cross section of the E-E position and a fluid flow having a rotational force for the microbubble generation device shown in FIGS. 3A and 3B.

FIG. 7 is a perspective view showing a typical state when a liquid and a gas enter in the microbubble generation device which has the double cylinder structure according to the present invention.

FIG. 8 is a diagram showing a typical production state of the liquid flow and vortex which occur in the microbubble generation device which has the double cylinder structure according to the present invention.

FIGS. 9A, 9B and 9C illustrate respectively a sectional view, a top view, and a front view, which show a modified example of the microbubble generation device which has the double cylinder structure according to the present invention.

FIGS. 10A, 10B, 10C and 10D illustrate respectively a top view, a front view, and cross sectional views, which show another modified example of the microbubble generation device having the double cylindrical structure according to the present invention.

FIG. 11 illustrates a top view, a front view, and cross sectional views, which show another different modified example of the microbubble generation device having the double cylindrical structure according to the present invention.

FIGS. 12A, 12B, 12C and 12D are respectively a top view, a front view, and cross sectional views, which show an example of an inner cylinder in which one or more though-slits are formed in a position different from a tangential direction in the microbubble generation device having the double cylinder structure according to the present invention.

FIG. 13 is a cross-sectional view showing another example of an inner cylinder in which through-slits are simultaneously formed at a tangential direction and a position different from a tangential direction for the microbubble generation device which has the double cylindrical structure according to the present invention.

FIGS. 14A and 14B are respectively a front view and a cross sectional view, which show a modified example of an inner cylinder in which through-holes are formed in the microbubble generation device having the double cylinder structure according to the present invention.

FIGS. 15A and 15B illustrate respectively a top view and a front view, which show the microbubble generation device used when operating in water, according to the present invention.

FIG. 16 is a cross sectional view when operating the bubble generation device shown in FIGS. 15A and 15B in water.

FIG. 17 is a cross sectional view showing a modified example which has a gas flow rate adjustment valve in the microbubble generation device shown in FIG. 16.

FIGS. 18A, 18B, 18C and 18D are respectively a top view, a perspective view, a front view and a cross sectional view, which show another modified example of the microbubble generation device shown in FIG. 15 and FIG. 16.

FIG. 19 is a cross sectional view showing an oil-water separation apparatus which has the microbubble generation device having the double cylinder structure according to the present invention.

FIG. 20A and 20B are respectively a cross sectional views, which show a modified example of the oil-water separation apparatus having the double cylinder structure according to the present invention.

### MODES FOR IMPLEMENTING THE INVENTION

The microbubble generation device according to embodiments of the present invention uses a simple mechanism of generating a swirling flow by injection of a pressurized liquid to generate microbubbles, the microbubble generation device comprising basically; a cylindrical or conical cylinder having a gas-liquid swirling chamber therein for forming a space where the gas-liquid can swirl: a gas-liquid discharge outlet arranged on one side of the cylindrical or conical cylinder for discharging the gas-liquid mixture in which the gas and the liquid are mixed in the gas-liquid swirling chamber; a liquid supply cylinder having a liquid introduction inlet for introducing the liquid into the gas-liquid swirling chamber; and a gas supply cylinder having a gas introduction port for introducing a gas into the gas-liquid swirling chamber.

Furthermore, in order to generate a large amount of microbubbles having a smaller particle diameter from the gas-liquid discharge outlet, a plurality of cylindrical through-holes having at least a small cross-sectional circle diameter are formed as the gas-liquid discharge outlet on one side end of a cylindrical or conical cylinder having the gas-liquid swirling chamber therein, or a plurality of small recessed parts having a circular cross-section and a circumference length equal to or larger than a half circle are formed as the gas-liquid discharge outlet from the gas-liquid discharge outlet to the middle along the longitudinal direction of the inner wall of the cylindrical or conical cylinder toward the inside thereof, on a circumferential surface of an inner wall of an end portion opened on one side of the cylindrical or conical cylinder.

FIGS. 1A and 1B illustrate an example of a device having a gas-liquid discharge outlet provided with a plurality of cylindrical through-holes in a conventional microbubble generation device using a swirling flow. FIGS. 1A and 1B are respectively a cross-sectional view taken along line A-A of the microbubble generation device and a bottom view when viewed from the direction of the gas-liquid discharge outlet. A microbubble generation device 1 shown in FIGS. 1A and 1B generate a gas-liquid swirling flow 8 of a gas-liquid mixture inside the gas-liquid swirling chamber 4 by introducing a pressurized liquid such as water from the liquid introduction inlet 7 of the liquid supply cylinder 6 toward a tangential direction of the gas-liquid swirling chamber 4 into the cylindrical or conical cylinder 5 having the gas-liquid swirling chamber 4 therein, while introducing a gas from the gas introduction inlet 3 of the gas supply cylinder 2, and discharges the gas-liquid mixture from the gas-liquid discharge outlet 10 by changing the large turning vortex flow of the gas-liquid swirling flow 8 into a small turning vortex flow 11 with a plurality of cylindrical through-holes 9 provided as the gas-liquid discharge outlet 10. FIGS. 1A and 1B illustrate an embodiment in which each of the eight cylindrical through-holes has a circular cross-sectional shape having the same diameter, and is provided symmetrically with respect to the center of an end wall surface closed on one side of a cylinder having the gas-liquid swirling chamber therein.

FIGS. 2A to 2C illustrate an example of a conventional microbubble generator using a swirling flow, in which a plurality of recessed parts having a small circular cross section and a circumferential length equal to or larger than a half circle are formed from the gas-liquid discharge outlet to the middle along the longitudinal direction of the inner wall of the cylindrical or conical cylinder toward the inside thereof, on a circumferential surface of an inner wall of an end opened on one side of the cylindrical or conical cylinder. In FIGS. 2A, 2B and 2C show a B-B cross-sectional view of the microbubble generation device, a bottom view when viewed from a direction of the gas-liquid discharge port, and an enlarged view of a peripheral part of the gas-liquid discharge port, respectively. The microbubble generation device 12 shown in FIGS. 2A and 2B basically generates a gas-liquid swirling flow 8 by the same mechanism as that of the device shown in FIGS. 1A and 1B. As a means for changing the large turning vortex flow of the gas-liquid swirling flow 8 into a small turning vortex flow 11, the gas-liquid mixing device 12 has a plurality of recessed parts 13 having a small circular cross-section and a circumference length equal to or larger than a half circle, which are provided from the gas-liquid discharge outlet 10 to the middle along a longitudinal direction of the inner wall of the cylindrical or conical cylinder 5 toward the inside thereof on a circumferential surface of an inner wall of an end portion opened on one side of the cylindrical or conical cylinder, differing from the device shown in FIGS. 1A and 1B. The recessed parts 13 have, for example, has a small semi-circular cross section having a same diameter d as shown in FIG. 2C, and are formed continuously in a state that they are adjacent to each other on the circumferential surface of the end part inner wall opened on one side of the cylindrical or conical cylinder 5. Thereby, a small vortex branch wall for changing a large vortex flow formed in the gas-liquid swirling chamber 8 into a small vortex flow is formed.

Thus, the microbubble generation device according to the present invention is characterized by having the gas- liquid discharge outlet 10 in which the plenty of cylindrical through-holes 9 or recessed parts 13 are formed to demonstrate a small vortex branch function for changing the large turning vortex flow of the gas-liquid swirling flow 8 formed in the gas-liquid swirling chamber 4 into a small turning vortex flow 11, as shown in FIGS. 1A and 1B or FIGS. 2A to 2C. Thereby, the conventional microbubble generation devices described in Patent documents 1 to 3 can also generate a large amount of microbubbles having a small particle size by simply adopting a new configuration and structure on the gas-liquid discharge outlet side. The new configuration and structure of the gas-liquid discharge outlet side adopted in the present invention can also be applied to a gas-liquid discharge port arranged in the microbubble generation device disclosed in Patent document 4. Thereby, the same effect can be obtained without changing other components and structures.

The through-holes 9 shown in FIGS. 1A and 1B or the recessed parts 13 shown in FIGS. 2A to 2C have a diameter smaller than a cross sectional diameter of the gas-liquid swirling chamber 4. Since the cross section of the through-holes 9 or the recessed parts 13 is circular, the large vortex flow of the gas-liquid swirling flow 8 is sent to the through-holes 9 or the recessed parts 13, and passes through the through-holes 9 or the recessed parts 13 in a state of being changed from the large vortex flow to the small vortex flows while maintaining the form of the swirling flow. At this time, the small vortex flows passing through the through-holes 9 or the recessed parts 13 decrease in pressure according to bernoulli's theorem, resulting in higher swirling speed of the gas-liquid swirling flow than that of the large vortex flow of the gas-liquid swirling flow 8. An instantaneous increase in pressure occurs when the small vortex flows are discharged to the outside from the gas-liquid discharge outlet. As the result, the bubbles contained in the gas-liquid swirl flow 8 are discharged with a very small particle diameter.

Here, the smaller the cross-sectional diameter of the through-holes 9 or the recessed parts 13, the higher the effect of reducing the diameter of the bubbles. The through-holes 9 or the recessed parts 13 are circular in the cross-section so that the small vortexes passing through the portions can maintain swirling flows. Furthermore the recessed parts 13 are required to have a circumferential length equal to or larger than a half circle of the circle cross-section. In the circular cross-sectional shape of the cylindrical through-holes 9 or the small recessed parts13, it is preferable that the circular diameter is less than ½ of the inner wall cross sectional diameter of the cylindrical or conical cylinder 5 having the gas-liquid swirling chamber 4 and the absolute value thereof is 10 mm or less so as to suppress an occurrence of turbulence in the swirling flows of the small vortexes and perform a stable formation of the swirling flow. When the diameter of the circular cross section of the through-holes 9 or the small recessed parts 13 is ½ or more of the inner wall cross-sectional diameter of the cylinder 5, a rate of changing from the large vortex to the small vortexes becomes small, thereby the effect of reducing the size of the microbubbles cannot be sufficiently obtained. When the cross sectional circular diameter of the through-holes 9 or the small recessed parts 13 is less than ½ of the inner wall cross sectional diameter of the cylinder 5, but the absolute value thereof exceeds 10 mm, the pressure change becomes small when discharging the small vortex flows to the outside from the gas-liquid discharge outlet, and the effect of reducing the size of the air bubble cannot be sufficiently obtained. In the present invention, it is practical from the viewpoint of including a workability point that the through-holes 9 or the recessed parts 13 have the circular cross section diameter of 1 to 10 mm as the absolute value, and more preferably 3 to 6 mm.

As described above, it is essential that that present invention have the through holes 9 or the recessed parts 13 as the gas-liquid discharge outlet to reduce the diameter of the microbubbles contained in the gas-liquid mixture to be discharged. This problem does not solve a fundamental problem even if the pressure of the liquid introduced from the liquid inlet is increased. Conversely, a large load is applied to the device, and abnormal noise may be generated during operation of the device. In addition, as disclosed in the invention described in Patent Document 2, the installation of another bottom surface of the donut type on the gas-liquid discharging outlet side, or the method of using the filter described in Patent Document 3, not only makes the structure of the device complicated, but also requires the technological skill and effort in adjusting the device when a large amount of microbubbles are to be produced. In addition, the life of the device tends to be shortened, and the device needs to be frequently maintained.

On the other hand, by providing a plurality of through holes 9 or small recessed parts 13 as the gas-liquid discharge port in the present invention, the particle diameter of the fine bubbles can be reduced without complicating the configuration and structure of the device. In addition, since a large amount of microbubbles can be generated by using multiple gas-liquid outlets, a synergistic effect can be obtained. Furthermore, since the configuration and structure of the device can be simplified, the device life can be extended without frequent maintenance.

In the microbubble generation device according to the present invention, it is preferable that the plurality of through holes 9 have the same diameter in the circular cross section, and are provided point-symmetrically with respect to the center of the end wall surface closed on one side of the cylindrical or conical cylinder having the gas-liquid swirling chamber therein (see FIGS. 1A and 1B). When the number of the through holes 9 is 2 or more, the effect of the present invention can be obtained, but the number is preferably 4 or more, and practically 50 or less from the viewpoint of workability. In the case where the small recessed parts 13 are provided, it is preferable that all of them have the same diameter in the cross-section circular shape, and are provided continuously in a state adjacent to each other on the circumferential surface of the inner wall of one end of the cylindrical or conical cylinder having the gas-liquid swirl chamber therein (see FIGS. 2A to 2C). By forming the plurality of through holes 9 or the small recessed parts 13 in such an arrangement, a large amount of microbubbles having a smaller particle diameter can be generated uniformly from the gas-liquid discharge outlet side. In addition, the turbulent flow of the gas-liquid mixture discharging on the gas-liquid discharge outlet side can be suppressed, and the discharging direction can be easily controlled.

In the present invention, for example, using the microbubble generation device having a double cylindrical structure, which will be described later, it is also possible to generate a large amount of microbubbles having a range of 1 to 30 nm by adopting a structure in which the small recessed parts having the semicircular cross section with the same diameter are continuously provided as the gas-liquid discharging outlet in an adjacent state to each other on the inner wall circumferential surface of one opened end portion of the cylindrical or conical cylinder, and by introducing the liquid at a pressure of 10 MPa or more from the liquid inlet. Here, the average particle diameter of the nano-bubbles can be measured with a cryo-transmission electron microscope using an ice embedded method as described in JP2016-095183 A1, for example. In addition, a measurement by a dynamic light scattering method (photon correlation method) is possible.

Compared to the conventional swirling flow microbubble generator, the microbubble generation device according to the present invention can generate smaller microbubbles and achieve an efficient mass generation of the microbubbles with a simpler configuration and structure by adopting not only a new structure on the discharge outlet side of the gas-liquid mixture to generate a large amount of microbubbles having a smaller diameter, but also a double cylinder structure comprising; an inner cylinder having the gas-liquid swirl chamber inside: and an outer cylinder container which the inner cylinder is inserted into, as mentioned above. In addition, it is possible not only to sustain the generation of microbubbles even during long-time operation, but also to have a compact device that is excellent in handling, operability and durability.

Hereinafter, preferred embodiments of the microbubble generation device having the double cylindrical structure according to the present invention will be explained in detail with reference to the drawings. However, the present invention is not limited to the following embodiments.

### First Embodiment

FIGS. 3A and 3B illustrate a plan view and a front view respectively, showing an example of the microbubble generation device according to the present invention. In FIGS. 3A and 3B, a reference numeral 14 denotes a main body of the microbubble generation device. The fine bubble generation device 14 comprises; a liquid supply cylinder 15: and an outer cylinder container 16. By supplying a liquid from one end opening of the liquid supply cylinder 15, a gas-liquid swirl flow is generated inside the microbubble generation device 14 and a gas-liquid is discharged from a gas-liquid discharging outlet 17 opened at the tip of the outer cylinder container 16. The internal structure of the microbubble generation device 14 shown in FIGS. 3A and 3B will be described in detail with reference to cross sectional views at positions of a cross-section C-C, a cross-section D-D, and a cross-section E-E. Furthermore, with reference to these cross-sectional views, the gas-liquid swirl flow generation mechanism according to the present invention and the effects produced thereby will be described together.

FIG. 4 is a diagram showing a cross-section at the C-C position of the microbubble generation device 14 shown in FIGS. 3A and 3B. As shown in FIG. 4, the microbubble generation device14 comprises; a cylindrical inner cylinder 18 as an internal structure; the columnar outer cylinder container 16 that forms a double cylindrical structure by inserting the inner cylinder 18 therein; and the liquid supply cylinder 15 having a liquid inlet 19 for introducing a liquid into the outer cylinder container 16. The inner cylinder 18 has a closed end 20 that is closed on the liquid supply cylinder 15 side and an open end 21 that is open on the side opposite to the liquid supply cylinder 15 side. The inner cylinder 18 has a gas-liquid swirling chamber 22 therein for creating a space where the gas-liquid can swirl. Furthermore, in the inner cylinder 18, through slits 23 (or through-holes) are formed between one end on the liquid supply cylinder 15 side and the middle along a longitudinal direction of the inner cylinder 18. The number of the through-slits 23 (or the through-holes) is one or more, and the shape and position thereof will be described in detail later with reference to FIG. 6. Furthermore, the inner cylinder 18 is integrated with the outer cylinder container 16 in which a gap 24 for introducing a pressurized liquid is formed between the outer wall of the portion having the through slits 23 (or the through- hole) and the inner wall of the outer cylinder container 16.

The pressurized liquid 15a supplied from one end opening of the liquid supply cylinder 15 is introduced into the outer cylinder container 16 from the liquid inlet 19 of the liquid supply cylinder 15. As shown by the flows 15b of the liquid, this pressurized liquid enters the gap 24 formed between the outer wall of the inner cylinder 18 and the inner wall of the outer cylinder container 16 and passes through the through-slits 23 (or it may be the through-holes) and is injected so as to rotate around the inner circumference of the inner cylinder 18. The gap 24 needs to be formed at least up to the portion where the through-slots 23 (the through-holes) are formed in the inner cylinder 18, since the pressurized liquid introduced from the liquid inlet 19 is uniformly ejected from the inner periphery of the inner cylinder 18 through the through-slits 23 (or the through-holes).

The pressurized liquid thus ejected starts to rotate while the liquid is pressed against the inner wall surface by a centrifugal force in the gas-liquid swirl chamber 22 inside the inner cylinder 18. Since the liquid that has started to rotate has a lower pressure at the center of the swirling vortex, a gas 25 existing at the end of the open end portion 21 of the inner cylinder 18 in the atmospheric pressure state is sucked. At this time the gas 25 is light, so the gas 25 is sucked toward the center of the gas-liquid swirling chamber 22, moves toward the end 20 closed on the liquid supply cylinder 15 side as indicated by 25a, is mixed with the pressurized liquid in the inner wall surface of the inner cylinder 18, and is mixed as bubbles contained inside the pressurized liquid in an apparently cloudy state while swirling together in the gas-liquid swirl chamber 22. The gas-liquid swirling flow generated in the gas-liquid swirling chamber 22 gradually goes to the open end 21 of the inner cylinder 18, and then the liquid containing microbubbles is injected by being discharged from the circular outer periphery of the end 21. Thus, the open end 21 of the inner cylinder 18 functions as a gas inlet 26 for introducing the gas into the gas-liquid swirling chamber 22 and the gas-liquid discharge outlet 17 from which the gas-liquid discharges from the gas-liquid swirl chamber 22. Therefore, these different functions can be obtained at different locations in one opening, that is, at the central portion (portion that functions as the gas inlet 26) and the peripheral portion (portion that functions as the gas-liquid discharge outlet 17).

FIG. 5 is a cross-sectional view taken along the D-D position of the microbubble generation device 14 shown in FIGS. 3A and 3B and is a view seen from the open end 21 thereof. As shown in FIG. 5, on the circumferential surface of the inner wall of the open end 21, a plurality of semicircular recessed parts 27 are formed from the gas-liquid projecting port 17 to the middle along a longitudinal direction of the inner cylinder 18 toward the liquid supply cylinder 15. By this semicircular recessed parts 27, the liquid mixed with the air coming out along the outer wall of the gas-liquid swirl chamber 22 by a centrifugal force is decomposed at that portion, and discharged in a form of rotating vortexes converted into small vortexes. A plurality of semicircular recessed parts 27 are formed equally on the circumferential surface of the inner wall of the end 21 to function as a small vortex branch wall 28.

As described above, the liquid rotates by being pressed against the inner wall surface of the inner cylinder 18 of the microbubble generating device 14 by the centrifugal force. By forming the small vortex branch wall on the shower nozzle surface in contact with the liquid, the liquid and the gas can be mixed more smoothly. Thereby, not only the bubbles can be made finer, but also a large amount of microbubbles can be generated.

FIG. 6 is a schematic diagram showing a cross-section at the E-E position of the microbubble generation device 14 shown in FIGS. 3A and 3B and the flow of fluid having a rotational force. As shown in FIG. 6, in the microbubble generation device 14 according to the present embodiment, the through-slits 23 are formed at four locations in the tangential direction of the inner cylinder 18, and are arranged at equal intervals in the circumferential direction of the inner cylinder 18. The pressurized liquid sprayed through the through-slits 23 to the inner wall of the inner cylinder 18 rotates as a vortex as indicated by 29, whereby the pressure at the center of the vortex 29 is lowered and a state is created where the pressure is lower than atmospheric pressure. And the gas-liquid mixed liquid is created by mixing with the gas sucked from the gas inlet 26 at the open end 21 of the inner cylinder 18. The state is shown in FIGS. 7 and 8. FIG. 7 is a perspective view showing a typical state when liquid and gas enter in the microbubble generation device according to the present invention. FIG. 8 is a schematic diagram showing a liquid flow and a vortex generation state occurring in the microbubble generation device according to the present invention.

Since the pressurized liquid forms a vortex while rotating as shown in FIG. 7, the atmosphere 25 is sucked toward the center of rotation. Since the liquid is heavier than the gas in mixing of the gas and the liquid, the liquid is pressed against the wall surface of the gas-liquid swirl chamber 22 existing inside the inner cylinder 18 by the centrifugal force. On the other hand, the gas is lighter, so the gas is sucked toward the center of the gas-liquid swirl chamber 22, and then toward the bottom of the gas-liquid swirl chamber 22 as shown by 15a, that is, the end 20 closed on the liquid supply cylinder 15 side in the inner cylinder 18. After that, the sucked gas is mixed with the liquid. Such the complicated conditions for sufficiently mixing in a complex mixed state of such the gas and the liquid can be obtained by optimizing the shape and structure of the inner cylinder and the through-slits.

As can be seen from the flow of liquid and the generation state of vortexes shown in FIG. 8, the pressurized liquid 15a is vigorously supplied and divided into 15b, and then performs a vortex rotation indicated by 15c. After that, the rotated vortex is branched to the small vortexes by changing to vortexes 15d by the small vortex branch wall 28 shown in FIG. 5. Here, since the center of the vortex indicated by 15c has a negative pressure, the gas is sucked into the negative pressure portion at the center of the vortex, whereby the gas is mixed with the liquid, causing the bubble to be generated.

As described above, using the microbubble generation device 14 according to this embodiment, a microbubble generation method comprises: supplying the pressurized liquid 15a from the liquid inlet 19 of the liquid supply cylinder 15, injecting and introducing a pressurized liquid 15a through the through-slits 23 (or the through-holes) formed in the inner cylinder 18 into the gas-liquid swirling chamber 22 inside the inner cylinder 18; mixing the gas 25 sucked from the gas inlet 26 under a negative pressure generated at the center of the swirling flow of the liquid that is formed by the centrifugal force created when the liquid jet is injected and introduced into the gas-liquid swirling chamber, with the liquid injected from a liquid injection port of the through-slits 23 (or the through-holes) at the liquid injection port and in the vicinity thereof; and discharging the gas-liquid swirling flow obtained by mixing of the liquid and the gas 25a through the inner wall surface of the inner cylinder 18 from the gas-liquid discharge outlet 17.

Next, the shape (length and width) of the through slit 23 formed in the inner cylinder 18 of the microbubble generation device 14 according to the present embodiment will be explained.

The through slit 23 is preferably such that L is greater than W and more L is twice W, where L is the length in the longitudinal direction of the inner cylinder 18 and W is the width in the direction perpendicular to the longitudinal direction. The through-slit formed in a rectangular shape having a long side in the longitudinal direction of the inner cylinder 18 (or the through-holes formed in an elliptical shape having a long axis) is effective for generating a high-speed gas-liquid swirling flow. On the other hand, the length of the depth is determined by the thickness of the inner cylinder 18.

Furthermore, the width (W) of the through-slits 23 shown in FIG. 4 and FIG. 6 needs to be ⅕ or less of the inner diameter of the inner cylinder 18, and preferably in the range of ⅛ to 1/20. By defining the width (W) of the through-slits 23 in the direction of narrowing to ⅕ or less, the speed of the liquid when injected from the through-slits 23 is greatly increased, thereby the liquid pressure can be further increased, compared with the pressurized liquid introduced from the liquid inlet 19. In order to generate a large amount of microbubbles, the prior arts require the liquid pressure to be increased when introduced under pressure. However, the microbubble generation device according to the present embodiment can increase the pressure of the liquid by the through-slits 23 without increasing the pressure of the liquid to be introduced under pressure so much, enabling to generate the gas-liquid swirling flow sufficient to generate a large amount of microbubbles. Thereby, the effect of suppressing an occurrence of the said cavitation erosion, which was a problem in the prior arts, is obtained. Furthermore, a higher-speed gas-liquid swirling flow can be generated by setting the width (W) of the through slit 23 to ⅛ or less, resulting in an enhanced effect of generating a large amount of microbubbles. However, when the width (W) of the through slit 23 is conversely too narrow, the amount of liquid that can be injected into the gas-liquid swirl chamber 9 tends to get lower, and the ability to generate a gas-liquid swirling flow tends to decrease. Therefore, the width of 23 is practically 1/20 or more.

The speed of the liquid ejected from the through-slits 23 is influenced not only by the absolute value of the width of the through-slits 23 but also by the internal volume of the inner cylinder 18 due to the pressure difference. Therefore, the width of the through slit 23 provided for obtaining the effect of the present invention is preferably defined by the ratio to the inner diameter of the inner cylinder 18.

Moreover, as shown in FIG. 6, it is preferable to have the plurality of through-slits 23 at equal intervals in the circumferential direction of the inner cylinder 18. In that case, it is possible to generate a large vortex of the gas-liquid swirling flow at a higher speed than a device having only one through-slit. Furthermore, by providing a plurality of through-slits 23 at equal intervals in the cross-sectional circumferential direction of the inner cylinder 18, it is possible to suppress a decrease in the speed of the gas-liquid swirling flow that is likely to occur due to the turbulent flow. Thus, in the present embodiment, it is preferable to provide the plurality of through-slits 23 in the circumferential direction of the cross section of the inner cylinder 18. However, the effects of the present invention can be obtained, even if the through-hole is formed in only one place.

When the through-slits 23 are provided in the tangential direction of the inner cylinder 18 as shown in this embodiment, there are the following two formation methods. One is a method of forming the through-slits on the closed end side by using an inner cylinder that has been molded in advance so as to have one end closed and the other open end. The other is a method of integrating by covering an end opening on the side where the through-slits are formed, after forming the through-slits in the tangential direction of the inner wall circumference of any one of the ends using a cylinder having ends open at both ends. Here, as a method of attaching the lid, any one of pressure welding molding, caulking molding, adhesion, and joining can be employed. In addition, as the inner cylinder or cylinder used in the both forming methods, the small vortex branch wall 28 made of a semicircular recessed parts 27, which is formed on the inner peripheral surface of the end opposite to the end forming the through slits, may be used.

In the present embodiment, the latter of the two formation methods is preferable because the through-slits 23 are easily formed and the width and length of the through-slits 23 can be formed with high accuracy. That is, the closed end portion located on the liquid supply cylinder 2 side comprises an open cylindrical end portion and a lid that closes the opening of the cylindrical end portion. What is closed with the lid by any of methods of fastening, bonding, and joining is used as the inner cylinder 18. In addition, as will be described later, when the through-slits 23 are not provided in the tangential direction of the inner cylinder 18, there is almost no difference between superiority and inferiority in the two formation methods. In that case, either method can be employed depending on the situation of the simplified manufacturing process and the cost reduction, etc..

Next, the shapes of the inner cylinder 18 and the outer cylinder container 16 forming a double cylinder structure formed in the microbubble generation device according to the present embodiment will be explained. The shapes of the inner cylinder 18 and the outer cylinder container 16 shown in FIGS. 3A and 3B and FIG. 4 are both cylindrical. In the present embodiment, they are not necessarily limited to the cylindrical shape, and may be conical. For example, either a shape in which the cross-sectional inner diameter gradually increases from the liquid inlet 19 toward the open end 21 of the cylinder that also serves as the gas inlet 26 (a conical shape in which the open end 21 side becomes a bottom surface), or a shape in which cross-sectional inner diameter gradually becomes narrow from the liquid inlet 19 toward the open end 21 (the conical shape in which the liquid inlet 19 side is the bottom surface), can be adopted. The former case can obtain an effect of increasing the amount of gas introduced from the gas inlet 26, while the latter can obtain an effect of gradually increasing the speed of the gas-liquid swirling flow toward the gas-liquid discharge outlet 17. However, the following problems may become remarkable when the conical shape is used. As the angle of inclination with respect to the bottom surface of the ridge line becomes smaller, the speed of the gas-liquid swirling flow drastically decrease in the former because the gas-liquid discharge outlet 17 becomes too wide. On the other hand, in the former the amount of gas to be introduced is reduced in the latter because the gas inlet 26 is too narrow. Therefore, it is preferable that the inclination angle of the conical ridge line with respect to the bottom surface is set in a range of 60 degrees or more and less than 90 degrees and is close to a cylindrical shape.

As described above, unlike the venturi system, the microbubble generation device according to the present embodiment does not need to form a gas injection tube or the like on the side surface of the outer cylinder container. Furthermore, unlike the microbubble generation device described in Patent Document 4, it is not necessary to provide a preliminary swirl portion, and to arrange a gas supply cylinder for introducing the gas into the gas-liquid swirling chamber in the center of a lower end wall surface of the liquid supply cylinder. Thus, the microbubble generation device according to the present invention has an excellent handling and operability, a high reliability and an improved durability, due to its superior feature in the configuration and structure of the inner cylinder 18, differing from those of the conventional microbubble generation device.

The fine bubble generation device 14 according to the present embodiment has a simple device configuration and can generate the rotating vortexes of the small liquid containing bubbles, and thus can be applied to, for example, a shower apparatus. Specifically, the microbubble generation device 14 is used as a shower nozzle for supplying water or hot water from one end opening located on the opposite side of the liquid inlet 19 in the liquid supply cylinder 15. This microbubble generation device is equipped in a shower apparatus that injects from a gas-liquid discharge outlet 17 of the microbubble generating device 14 to a desired portion (for example, skin) of the human body in a state where bubbles are contained in the water or the hot water. When hot water is used as the pressurized liquid, the gas-liquid mixed with liquid and air hits the skin as it is sprayed while rotating, so the addition of a stimulation caused by the bursting of bubbles, a massaging power by the rotating hot water, and a water pressure of the shower can synergistically promote a blood circulation. Thereby, the effect of an efficient cleaning and massaging can be obtained. Moreover, this shower apparatus can create the cleaning effect of the new sense which is not in the past, since this shower apparatus discharges the water in a polka dot state from the exit of a shower nozzle.

### Second Embodiment

FIGS. 9A, 9B and 9C illustrate respectively a cross-sectional view, a plan view, and a front view of a modified example of the microbubble generation device having a double cylindrical structure according to the present invention. The cross-sectional view shown in FIG. 9A shows a cross section taken along the line F-F in FIG. 9B. As shown in FIG. 9C, the microbubble generation device 30 comprises: a liquid supply cylinder 31 having a bent part (elbow part); an outer cylinder container 32; an air holder 33; and a gas supply cylinder 34. By supplying the liquid from one end opening of the liquid supply cylinder 31, a gas-liquid swirling flow is generated inside the fine bubble generation device 30, and a gas-liquid is discharged from the gas-liquid discharging outlet provided at the opening part around the air holder 33 at the tip side of the outer cylinder container 32. The internal structure of the fine bubble generating device 30 shown in FIGS. 9A, 9B and 9C will be explained with reference to FIG. 9A. In addition, the gas-liquid swirling flow generation mechanism according to the present invention and the effects produced thereby will be described with reference to the sectional view F-F.

As shown in FIG. 9A, the microbubble generation device 30 comprises: a cylindrical inner cylinder 36 as an internal structure; a cylindrical shape that forms a double cylindrical structure by inserting the inner cylinder 36 therein; and a liquid supply cylinder 31 having a liquid inlet 38 for introducing a liquid 37 into the outer cylinder container 32. The inner cylinder 36 comprises: an open end connected to a gas inlet 39 of a gas supply cylinder 34; a gas-liquid discharge outlet 35 in which an air holder 33 is included on the side opposite to a gas supply cylinder 34 and the periphery of the air holder 33 is opened; and a gas-liquid swirl chamber 40 that is a space in which gas-liquid can swirl. Here, the air holder 33 has the shape of an airtight container except that a vent hole 41 is formed in a portion that contacts the inner cylinder 36. Furthermore, through-slits 42 (or one or a plurality of vertically arranged through-holes) in the inner cylinder 36 are formed from one end on the liquid inlet 38 side to the middle of the inner cylinder 36 along the longitudinal direction thereof. The through-slits 42 (or one or a plurality of through-holes arranged vertically) may be formed by one or more numbers. The shape and position of the through-slits 42 can adopts, for example, one shown in FIG. 6 (or in FIG. 14A described later). Furthermore, the inner cylinder 36 is integrated with the outer cylinder container 32 which has a gap 43 for introducing a pressurized liquid between the outer wall of the portion where the through-slits 42 (or the through-holes) are formed, and the inner wall of the outer cylinder container 32.

The pressurized liquid 37 supplied from the opening at one end of the liquid supply cylinder 31 is introduced into the outer cylinder container 32 from the liquid inlet 38 of the liquid supply cylinder 31. As indicated by the liquid flow 37a, the pressurized liquid 37 enters the gap 43 provided between the outer wall of the inner cylinder 36 and the inner wall of the outer cylinder container 32, and is injected the through slits 42 formed in the inner cylinder 36 (or may be one or the plurality of through-holes arranged in a vertical array) so as to rotate on the inner periphery of the inner cylinder 36. The gap 43 needs to be formed at least up to a portion where the through slits 42 (or one or a plurality of vertically arranged through holes) are formed in the inner cylinder 36, so that the pressurized liquid introduced from the liquid inlet 38 is uniformly injected through the through-slits 42 (or one or the plurality of through-holes arranged in a vertical array) from the inner circumference of the inner cylinder 36.

The pressurized liquid injected in this manner starts to rotate while being pressed against the inner wall surface by a centrifugal force in the gas-liquid swirling chamber 40 arranged inside the inner cylinder 36. Since the pressure of the liquid that has started to rotate becomes lower toward the center of the swirl vortex, the gas 44 in the atmospheric state is sucked through the gas inlet 39 and the vent 41 of the air holder 33 from the gas supply cylinder 34 into the gas-liquid swirling chamber 40. Here, the gas 44 is not limited to atmospheric air, and may be sent as the pressurized air. The gas 44 fed in the gas supply cylinder 34 is mixed as bubbles in the pressurized liquid in an apparently clouded state while swirling together inside the gas-liquid swirling chamber 40 by mixing with the pressurized liquid 37 introduced from the liquid inlet 38. The gas-liquid swirling flow generated in the gas-liquid swirling chamber 40 gradually goes to the opening (the gas-liquid discharge outlet 35) between the inner wall of the inner cylinder 36 and the air holder 33. After that, the liquid containing microbubbles is ejected in a discharged from the gas-liquid discharge outlet 35.

As shown in FIG. 9B, the microbubble generating device 30 has a plurality of semicircular recessed parts 45 with the same shape which are formed from one end of the mouth 35 to the middle along a longitudinal direction of the inner wall of the inner cylinder 36 toward the inside thereof. The liquid mixed with the air which comes out along the outer wall of the gas-liquid swirling chamber 40 by a centrifugal force is decomposed with this semicircular recessed parts 45 at that portion, and is discharged by converting the rotating vortex into small vortexes. The plurality of semicircular recessed parts 45 form a small swirling branch wall for changing a large swirl vortex formed in the gas-liquid swirling chamber 40 into the small swirl vortexes by being provided uniformly on the circumferential surface of the inner wall of the gas-liquid projecting outlet 35.

As described above, the microbubble generation device 30 shown in FIGS. 9A, 9B and 9C has a configuration different from that of the first embodiment in that the gas-liquid introduction inlet 38 is provided on the side opposite to the gas-liquid discharge outlet 35. However, both of them are functionally the same, thereby the effect of generating a large amount of bubbles having a smaller particle diameter can be obtained in the same manner as the first embodiment.

### Third Embodiment

FIGS. 10A, 10B, 10C and 10D illustrate respectively a plan view, a front view, and cross-sectional views, which show another modified example of the microbubble generation device having a double cylindrical structure according to the present invention. FIGS. 10C and 10D illustrate respectively cross-sectional views showing the cross-sections at the G-G position in FIG. 10B and at the H-H position in FIG. 10C. As shown in FIGS. 10A and 10B, the microbubble generation device 46 comprises: a liquid supply cylinder 47; an outer cylinder container 48; and a gas supply cylinder 49. In the microbubble generation device 46, a gas-liquid swirling flow is generated inside the microbubble generation device 46 by supplying the liquid from one end opening of the liquid supply cylinder 47 arranged in a perpendicular direction to the outer cylinder, and the gas-liquid mixture is discharged from gas-liquid discharge outlet 50 opened at the tip of the outer cylinder container 48. The internal structure of the microbubble generator 46 is explained using FIG. 10C. A generation mechanism of the gas-liquid swirling flow according to the present invention and the effects produced thereby are also explained with reference to FIG. 10D.

As shown in FIG. 10C, the microbubble generation device 46 has a the inner structure, the inner structure comprising: a cylindrical inner cylinder 51 having a step as an internal structure; an outer cylinder container 48 forming a double cylindrical structure by inserting the inner cylinder 51 therein; and a liquid supply cylinder 47 provided with a liquid inlet 53 for introducing a liquid 52 into the outer cylinder container 48. The inner cylinder 51 comprises: an opening end connected to a gas inlet 54 of the gas supply cylinder 49; and the gas-liquid discharge outlet 50 opened on the opposite side to the gas supply cylinder 49 side. The inner cylinder 51 also has a gas-liquid swirling chamber 55 therein to create a space where a liquid can swirl. Furthermore, the inner cylinder 51 has through-holes 56 (or through-slits) formed from one end on the liquid inlet 53 side to the middle along of a longitudinal direction of the inner cylinder 51. The number of the through-holes 56 (or the through-slits) is formed by one or more. For example, as shown in FIG. 10D, three through-holes (or through-slits) can be formed in the tangential direction in the circular section of the inner wall of the inner cylinder 51. Furthermore, the inner cylinder 51 is integrated with the outer cylinder container 48 in a configuration of forming a gap 57 for introducing pressurized liquid between the outer wall of the portion where the through-holes 56 (or the through-slits) are formed, and the inner wall of the outer cylinder container 48.

The pressurized liquid 52 supplied from the liquid supply cylinder 47 changes direction and is introduced into the outer cylinder container 48. The pressurized liquid 52a enters the gap 57 formed between the inner wall of the outer cylinder container 48 and the outer wall of the inner cylinder 51, and are injected to rotate around the inner cylinder 51 after passing through the through-holes 56 (or the through-slits) formed in the inner cylinder 51.

The pressurized liquid injected in this way starts to rotate while being pressed against the inner wall surface by a centrifugal force in the gas-liquid swirling chamber 55 formed inside the inner cylinder 51. Since the liquid starting the rotation has a lower pressure at the center of the swirling vortex, a gas in the atmospheric state is sucked in from two directions. One of the sucked gas is an air 58 introduced through the gas introduction port 54 from the gas supply cylinder 49, and the other is an air 59 introduced from the end of the inner cylinder 51 which is opened on the gas-liquid discharge outlet 50 side. Here, the air 58 introduced through the gas introduction port 54 can optimize a gas flow rate by using the valve 60 for controlling the introduction amount of the gas. This improves the usability of the device.

As described above, the present embodiment has a configuration different from those of the first and second embodiments in that the gas is introduced from the two front and rear directions of the microbubble generation device. Here, the airs 58 and 59 are not limited to air in the atmospheric state, and may be sent as a pressurized air.

The fed gases 58 and 59 are mixed with the pressurized liquid 52 introduced from the liquid supply cylinder 47, and are swirled together in the gas-liquid swirl chamber 55. The mixing of the fed gases takes place as gas bubbles while appearing cloudy in the pressurized liquid. A gas-liquid swirling flow generated in the gas-liquid swirling chamber 55 gradually goes to the open end of the inner cylinder 51, and the liquid containing microbubbles is discharged in a form discharged from the gas-liquid discharge outlet 50.

As shown in FIG. 10A, the microbubble generation device 46 has a plurality of cylindrical through-holes 61 which are formed in the circumferential direction of the end portion opened on the gas-liquid discharge outlet 50 side in the inner cylinder 51. The cylindrical through-holes 61 are used as the gas-liquid discharge outlet 50. The liquid mixed with the air coming out along the outer wall of the gas-liquid swirl chamber 55 by the centrifugal force is discharged while changing a rotating vortex into small vortexes by decomposition at the portion of the cylindrical through-holes 61. The cylindrical through-holes 61 have a small vortex branching function by being formed uniformly in plural in the circumferential direction of the open end of the inner cylinder 51.

Thus, the microbubble generation device 46 shown in FIG. 10 is an effective device due to a configuration in which the gas can be introduced simultaneously from the front and back of the device, when it is desired to put more gas than liquid. Furthermore, by providing the plurality of cylindrical through-holes 61 having the small vortex branching function as the gas-liquid discharge outlet 50, an effect of generating a larger amount of bubbles having a smaller particle diameter than in the first and second embodiments can be enhanced.

### Fourth Embodiment

FIGS. 11A, 11B, 11C, 11D, 11E and 11F illustrate respectively a top view, a front view, and a cross sectional views, which show still another modified example of the microbubble generation device having the double cylindrical structure according to the present invention. FIGS. 11C and 11D show respective cross sectional views at the I-I position and J-J position of FIG. 11B and at the K-K position of FIG. 11C. Furthermore, the square dotted line frame in FIG. 11E schematically shows a gas flow when it is introduced into the gas-liquid swirl chamber in the cross sectional view J-J.

As shown in FIGS. 11A and 11B, a microbubble generation device 62 comprises: a liquid inlet 63; an outer cylinder container 64; and a gas inlet 65. By supplying a liquid from a liquid supply cylinder (not shown in the figure) connected to the liquid inlet 63, a gas-liquid swirling flow is generated inside the microbubble generation device 62, and a gas-liquid is discharged from a gas-liquid discharge outlet 66 opened at the tip of the outer cylinder container 64. The internal structure of the microbubble generation device 62 shown in FIGS. 11A, 11B, 11C, 11D, 11E and 11F will be explained with reference to FIG. 11C. Furthermore, with reference to FIG. 11F, the gas-liquid swirling flow generation mechanism according to the present invention and the effects produced thereby will be described together.

As shown in FIG. 11C, the microbubble generation device 62 has an inner structure, the inner structure comprising: a cylindrical inner cylinder 67; a cylindrical outer cylinder container 64 that apparently forms a double cylindrical structure by inserting the inner cylinder 67 therein; and the liquid inlet 63 for introducing a liquid 68 into the outer cylinder container 64. The inner cylinder 67 comprises: an open end 69 connected to the gas inlet 65: a gas-liquid discharge outlet 66 opened on the opposite side to the gas inlet 65 side; and a gas-liquid swirling chamber 70 therein, forming a space where the gas-liquid can swirl. Furthermore, the inner cylinder 67 has through-holes 71 (or through-slits) which are formed from one end on the liquid inlet 63 side to the middle along a longitudinal direction of the inner cylinder 67. The number of through-holes 71 (or the through-slits) is one or more. For example, as shown in FIG. 11F, six through-holes 71 (or the through-slits) can be formed in the tangential direction in the circular section of the inner wall of the inner cylinder 67.

The pressurized liquid 68 supplied from the liquid inlet 63 is introduced into a passage 72a formed in the inner cylinder 67 which is integrated with the outer cylinder container 64. The pressurized liquid 68a passing through the passage 72a enters a passage 72b close to the through hole 71 (or the through slit) formed in the inner cylinder 67, and is injected through the through-holes 71 (or the through-slits) so as to rotate around the inner periphery of the inner cylinder 67. Here, the passage 72b close to the through-hole 71 (or the through-slit) corresponds to a gap formed between the inner wall of the outer cylinder container and the outer wall of the inner cylinder in the first to third embodiments. The inner cylinder 67 is integrated with the outer cylinder container 64 via a sealing O-ring 73 in order to improve airtightness so that liquid does not leak from the passage 72b.

The pressurized liquid thus ejected starts to rotate while being pressed against the inner wall surface by a centrifugal force in the gas-liquid swirling chamber 70 inside the inner cylinder 67. Since the liquid starting to rotate has a lower pressure at the center of a swirling vortex, a gas in the atmospheric state is sucked in from two directions. One of the sucked gas is an air 75 introduced from a gas inlet 65 provided perpendicular to the longitudinal direction of the microbubble generation device 62, and the other is an air 74 existing at the tip of an end opened on the gas-liquid discharge outlet 66 side in the inner cylinder 67. In the former case, that is, the air 75 introduced from the gas inlet 65 is divided into two directions and opened at the center of the inner cylinder 67 as shown in the cross sectional view J-J and is introduced into the gas-liquid swirling chamber 70 through a small hole 76 opened at the center of the inner cylinder 67. Here, at least one of the airs 75 and 74 introduced from the gas inlet 65 and the gas-liquid discharge outlet 66 is not limited to atmospheric air, and may be sent as pressurized air.

The introduced airs 75 and 74 are mixed with the pressurized liquid 68 introduced from the liquid inlet 63, and are swirled together in the gas-liquid swirling chamber 70. The mixing of the fed gases takes place as gas bubbles while appearing cloudy in the pressurized liquid. The gas-liquid swirling flow generated in the gas-liquid swirling chamber 70 gradually goes to the open end of the inner cylinder 67, and the liquid containing microbubbles is ejected in a form discharged from the gas-liquid discharge outlet 66.

As shown in FIG. 11A, the microbubble generation device 62 has semicircular recessed parts 77 having the same shape as that shown in FIG. 5, which are formed to the middle along the longitudinal direction of the inner wall toward the inside of the inner cylinder 67 from one end thereof toward the inside therein on the circumferential surface of the inner wall of the inner cylinder 67. The liquid mixed with the air coming out along the outer wall of the gas-liquid swirling chamber 70 by a centrifugal force can be discharged by being decomposed at the semicircular recessed parts 77 and changed from a rotating vortex to small vortexes. The plurality of semicircular recessed parts 77 function as a small vortex branch wall for changing the large swirling vortex formed in the gas-liquid swirling chamber 70 into the small swirl vortexes by being provided uniformly on the inner wall circumferential surface of one end of the gas-liquid discharge outlet 66.

The microbubble generation device 62 shown in FIGS. 11A, 11B, 11C, 11D, 11E and 11F has a gap which is replaced with a passage 72b close to the through-holes 71 (or the through-slits) formed in the inner cylinder 67, differing from the gap formed between the inner wall of the outer cylinder container and the outer wall of the inner cylinder in the first to third embodiments. Moreover, the microbubble generation device 62 has the same function as the third embodiment shown above in that the gas is introduced into the gas-liquid swirling chamber from two directions of the microbubble generation device, but differs from the third embodiment in that the gas 75 is introduced from the gas inlet 65 provided as one of the two directions perpendicularly to the longitudinal direction of the microbubble generation device 62.

As described above, the microbubble generation device 62 shown in FIGS. 11A, 11B, 11C, 11D, 11E and 11F has a configuration and structure different from those of the first to third embodiments. However, the microbubble generation device 62 can generate a large amount of bubbles having a smaller particle diameter by providing the plurality of cylindrical through-holes 77 having a small vortex branching function as the gas-liquid discharge outlet as well as a configuration capable of simultaneously introducing the gas from two directions of the apparatus.

The microbubble generation device 62 shown in FIG. 11, which is arranged in a normal shower head, can generate bubbles by introducing the gas from the gas inlet 65, and discharge the liquid containing a large amount of bubbles with a small particle diameter from a small hole at the outlet of the shower. Therefore, not only can the cleaning effect be improved remarkably, but it can also be applied to devices such as a hot water shower that also requires a water-saving effect.

### Fifth Embodiment

In the first embodiment, the example of the microbubble generation device in which the through-slits 23 are formed in the tangential direction of the inner cylinder 18 has been described. However, in the present invention, the position where the through slits are provided is limited to the tangential direction of the inner cylinder. FIGS. 12A to 12D illustrate an example of an inner cylinder in which through-slits are formed at a position different from the tangential direction in the microbubble generation device according to the present invention. FIGS. 12A, 12B, 12C and 12D are respectively a plan view and a front view of the inner cylinder 78, a cross sectional view at the O-O position shown in FIG. 12A, and a cross sectional view of the Q-Q position shown in FIG. 12B.

As shown in FIGS. 12A to 12D, an inner cylinder 78 according to the present embodiment is different only in the formation position of through-slits 79. Semicircular recessed parts 80 are formed from the opening portion of an open end 82 (corresponding to the gas-liquid discharging outlet) to the middle along a longitudinal direction of an inner wall toward the closed end 83 of the inner cylinder 78. As described in the first embodiment, the semicircular recessed parts 80 function as a small vortex branch wall 81 that converts a rotating vortex into small vortexes and discharges the small vortexes.

As shown in FIGS. 12B and 12D, the inner cylinder 78 of the present embodiment has the through-slits 79 provided at two locations near the closed end portion 83. The inner cylinder 78 according to the present embodiment is characterized by a position where the through-slits 79 are formed. That is, as shown in FIG. 12B, it is preferable that the through-slits 79 is formed to have an opening passage in which the injection direction is adjusted so that the position of P is included within a distance range of r/2 or less from the inner wall of the cross section of the inner cylinder 78 on the vertical line N toward the center, when the inner wall circle radius of the cross section of the inner cylinder 78 is r, and the position of the inner wall section of the inner cylinder 78 where the injected liquid collides corresponds to the projected position onto the perpendicular line N drawn with respect to the tangent line M of the inner wall circle parallel to the liquid ejection direction (the part indicated by →), defined the projected position to be P. Thereby, the vortex 84 by the gas-liquid swirl flow can be generated in the gas-liquid swirling chamber inside the inner cylinder 78. If the position P shown in FIG. 12D exceeds r/2, a liquid ejected from the through-slit 79s is reflected or scattered after colliding with the inner wall surface of the inner cylinder 78, thereby the amount of liquid creating the gas-liquid swirling flow decreases or the flow of the gas-liquid swirling flow is greatly disturbed, resulting in making it difficult to generate the vortex 84.

By incorporating the internal cylinder 78 provided with two through-slits 79 at a distance of r/4 from the inner wall of the cross section toward the center into the microbubble generation device shown in FIGS. 3A and 3B, a qualitative examination was actually conducted on the state of bubble formation. As a comparative example, a state of generating bubbles was also investigated using another inner cylinder provided with two through slits at a distance of 3r /4, which was similarly incorporating into the microbubble generation device shown in FIG. 3. As a result of comparing both of the bubble generation conditions, the former according to the present embodiment was confirmed to generate a large amount of fine bubbles, whereas an amount of bubbles generated in the latter comparative example was small. Thus, it was found that there was a large difference between the two.

The position of P in the present embodiment can be defined within the same range even when the through-slits 23 are provided in the tangential direction as in the inner cylinder 18 used in the first embodiment. That is, in the first embodiment, the position of P defined in the present embodiment is a position where the position of the inner cylinder 18 is 0 (zero) from the inner wall of the cross section of the inner cylinder 18 to the center, being included in the range of a distance of r/2 or less. Accordingly, as a modified example of the inner cylinder used in this embodiment, the inner cylinder which has penetration slits in any of positions of a tangential direction and any of different positions from a tangential direction simultaneously may be used, as shown in the cross-sectional view of FIG. 13. The inner cylinder 85 shown in FIG. 13 has two through-slits 86 and 87 formed in a tangential direction of the inner wall and in a direction different from the tangential direction. When the inner cylinder 85 shown in FIG. 13 was incorporated into the microbubble generation device shown in FIG. 1, and the bubble generation state was observed, a large amount of microbubbles was qualitatively observed than a case of using the inner cylinder 79 shown in FIG. 12 is used.

In the present embodiment, the through-slits 79, 86, and 87 formed in the inner cylinders 78 and 85 shown in FIG. 12 and FIG. 13 can be defined within the same range as that defined in the first embodiment with respect to the length (L) and the width (W). This is because only the formation positions of the through-slits are different, and there is no significant difference in the shape of the through-slits. That is, in the length (L) and width (W) of the through-slits shown in FIG. 12B, L is larger than W, and W is preferably ⅕ or less of the inner diameter of the inner cylinder 17 or 24 and more preferably, W is in the range of ⅛ to 1/20.

### Sixth Embodiment

FIGS. 14A and 14B illustrate another modified example of an inner cylinder in which through-holes are provided instead of the through-slits in the microbubble generation device according to the present invention. FIGS. 14A and 14B are a front view and a cross-sectional view taken along the line R-R shown in FIG. 14A for the inner cylinder 88, respectively. The inner cylinder 88 shown in FIG. 14 has a small vortex branch wall composing a plurality of semicircular recessed parts on the circumferential surface of the inner wall of an open end 89 of the inner cylinder 88, like the inner cylinder 18 shown in FIG. 4.

As shown in FIG. 14A, the inner cylinder 88 used in the present embodiment has a plurality of through-holes 91 arranged in a straight line at two locations close to a closed end 90. The inner cylinder 88 of this embodiment is different in that the plurality of through-holes 91 are formed instead of the through-slits 79 formed in the inner cylinder 78 shown in FIGS. 12A to 12D. However, the formation position of the through-holes 91 is substantially the same as those of the through slits 79 in the inner cylinder 78 shown in FIGS. 12A to 12D (see FIG. 14B). In the plurality of through-holes 91 arranged in a longitudinal direction of the inner cylinder 88, L is formed in a shape larger than W, when the distance between the centers of the through holes at both ends is L, and the diameter or length of the through-holes 91 in the direction perpendicular to the longitudinal direction of the inner cylinder 88 is W. Thereby, the same function as the case of the through-hole slits described in the fifth embodiment is demonstrated, and a gas-liquid swirling vortex 92 sufficient to generate a large amount of microbubbles can be formed. In order to sufficiently obtain this effect, it is preferable that the relationship of L≥2×W is further satisfied, and the number of the through-holes 91 is also adjusted and determined so as to satisfy the relationship.

FIGS. 14A and 14B show an example in which the plurality of through-holes 91 are provided in the inner cylinder 88. When the through-holes 91 have an elliptical shape, the inner cylinder structure with a single unit may be adopted by setting the long axis (axis corresponding to the L) to be longer than the short axis (axis corresponding to the W) and L to be twice or more than W. Here, the through-holes 91 having a rectangular shape and a large ratio of L to W can be regarded as through-slits.

By incorporating the inner cylinder according to the present embodiment and the fifth embodiment into the microbubble generating device, it can be applied as a nozzle of the shower device in the same manner as the fine bubble generation device according to the first embodiment. Therefore, an efficient cleaning and massaging effect can be obtained from the shower apparatus.

### Seventh Embodiment

Each of the microbubble generation devices according to the first to sixth embodiments can be used mainly as a shower nozzle. These microbubble generating devices can be modified or enlarged to be used for transporting and farming aquatic organisms, purification of water quality, resuscitation of water environment, and the like. That is, a large amount of gas bubbles such as air generated by the bubble generation device can be put into dirty water that is contained in a water tank, a lake and so on.

FIGS. 15 and 15B illustrate respectively a plan view and a front view showing the microbubble generation device according to the present invention when operated by being put in water. In FIG. 15B, 93 is a main body of the microbubble generation device, comprising: a liquid supply cylinder 94; an outer cylinder container 95; and a cylindrical tube 96 which is inserted from the end opened at the tip of the outer cylinder container 95 so as to suck an external gas. FIG. 16 is a cross sectional view of the S-S position in a state where the microbubble generation device 93 shown in FIGS. 15A and 15B is actually put in water.

As shown in FIG. 16, the cylindrical tube 96 is used in the microbubble generation device having the same configuration and structure as those shown in FIG. 4. The cylindrical tube 96 is inserted through the gas-liquid swirling chamber 99 from the open end 98 opened in the inner tube 97 to the bottom of the gas-liquid swirling chamber 99, that is, toward the closed end 100, and is set in a little floating state from the closed end 100. The cylindrical tube 96 extends from the water to the atmosphere, and is provided for sucking the atmospheric gas 101 and blowing the gas 101 into the gas-liquid swirling chamber 99 located inside the inner cylinder 97. The cylindrical tube 96 has the same function as a straw tube. Here, in the vicinity of the closed end 100 of the inner cylinder 97, through-slits 103 (or through holes) are formed for injecting the pressurized liquid 102 into the inner cylinder 94, as described in the first, fifth and sixth embodiments.

The operation when the microbubble generation device shown in FIG. 16 is used as a nozzle will be explained.

As shown in FIG. 16, the rotational force of the liquid ejected through the through-slits 103 (the through-holes) into the inner cylinder 97 is adjusted by introducing water with an adjusted water volume and a water pressure from the outside, after the microbubble generating device 93 is submerged in the water as a bubble generating nozzle. A liquid swirling flow is generated by a rotational force of the liquid, and the gas 101 sucked from the cylindrical tube 96 is forcibly supplied to the center of the swirling flow to generate a gas-liquid swirl flow containing gas. Bubbles 104 can be generated in the water by discharging the swirling flow of vortex rotation created thereby from the open end 98 of the inner cylinder 97. Furthermore, a depth of sinking the main body of the microbubble generation device 93 may be reduced and the cylindrical tube 96 may be arranged so as to be inserted in the main body of the microbubble generation device 93 later. Even in that case, a gas 101 can be sucked from the cylindrical tube 96 by the negative pressure created by the vortex rotation, so that bubbles can be generated in water.

Furthermore, a liquid 102 is forcedly pushed from the opening of the liquid supply cylinder 94 by using a pump or the like to create the vortex as described above, and the gas 101 is sucked in from the opening at the tip of the cylindrical tube 96 with a negative pressure. Or the nozzle of the microbubble generation device 93 may be set at a deep water depth in a state of pressing the gas 101 in advance. Thereby, bubbles can be generated. Underwater such as an aquarium or a lake can be agitated by the action of relatively large bubbles using this. This action can be realized by, for example, the configuration of the microbubble generation device shown in FIG. 17.

FIG. 17 is a cross-sectional view showing a modified example of the microbubble generation device having a gas flow rate adjusting valve in the microbubble generation device shown in FIG. 16. The microbubble generation device 105 shown in FIG. 17 is one having the same configuration and structure as the microbubble generator 93 shown in FIG. 16, which is placed in water, and can adjust the size of bubbles by using the gas flow rate adjustment valve 106 when the gas 101 is introduced. The gas flow rate adjustment valve 106 is arranged at the entrance of the cylindrical tube 96 or in the middle thereof. The microbubble generation device 105 can adjust the pressure of the gas 101 by the gas flow rate adjusting valve 106, as described above. Therefore, the microbubble generation device 105 promotes to generate vortexes by the action of large bubbles, and thereby can generate a large amount of microbubbles 104, even when submerged in deeper water.

The microbubble generation device 93 shown in FIGS. 15A, 15B and 16 is configured so as to insert the cylindrical tube 96 to the closed end portion 100 of the inner tube 97 and set it in a state slightly lifted from the end portion 100. This embodiment is not limited to this structure. For example, what connects the cylindrical tube to an opened edge portion is included. The example is shown in FIGS. 18A to 18D. FIGS. 18A to 18D illustrate another modified example of the microbubble generation device shown in FIGS. 15A, 15B and 16, wherein FIGS. 18A, 18B, 18C and 18D are a plan view, a perspective view, a perspective view, and a cross-sectional view at a T-T position shown in FIG. 18A, respectively.

In a microbubble generation device 107 shown in FIGS. 18A to 18D, a cylindrical tube 111 is connected or joined to a closed end 110 of an inner tube 109 inserted into an outer tube container 108, and a gas introduction through-hole112 is formed in the vicinity of the closed end 110 in the cylindrical tube 111. The gas introduction through hole 112 is arranged to introduce a gas 113 sucked from the cylindrical tube 111 into a gas-liquid swirling chamber 114 inside the inner cylinder 109. Two or more of the gas introduction through holes 112 are preferably arranged at equal intervals in the circumferential direction. In addition, through-holes 115 are formed in the inner cylinder 109 in place of the through-slits shown in FIG. 16.

As shown in FIGS. 18A to 18D, a pressurized liquid 116 is supplied from a liquid supply cylinder 117 and introduced into the outer cylinder 108 from a liquid inlet 118. After that, the pressurized liquid 116 passing through the through-holes 115 formed in the inner cylinder 109 is injected into the gas-liquid swirling chamber 114. In the gas-liquid swirling chamber 114, the center of the inner cylinder 109 becomes negative pressure due to the swirling of the injected liquid. This causes the gas 113 sucked from the cylindrical tube 111 to enter from the gas introduction through-hole 112 to the gas-liquid swirling chamber 114. After that, a liquid containing small bubbles is formed by mixing the liquid injected in the gas-liquid swirling chamber 114 and the sucked gas, and the liquid containing small bubbles is discharged from the gas-liquid discharge outlet 119. The inner cylinder 109 has a small vortex branch wall 120 having a plurality of semicircular recessed parts, which is formed on the inner wall circumferential surface of the open end that forms the gas-liquid discharge outlet 119. Therefore, the gas-liquid discharged from the gas-liquid discharge outlet 119 contains microbubbles. Thus, the microbubble generation device shown in FIGS. 18A to 18D is basically the same as the device shown in FIGS. 15 and 16 except for the structure of the cylindrical tube, and can generate a large amount of microbubbles.

As described above, the method for generating microbubbles in the state of being immersed in the liquid using the microbubble generation device according to the present embodiment, fundamentally comprises; for example, as shown in FIGS. 15A, 15B and FIG. 16, injecting and introducing the pressurized liquid into the gas-liquid swirling chamber 99 inside the inner cylinder 97 through the through-slits 103 (or the through- holes) formed in the inner cylinder 97 by supplying the pressurized liquid from the liquid inlet of the liquid supply cylinder 94; introducing the gas 101 through the cylindrical tube 96 from the outside into the gas-liquid swirling chamber 99 inside the inner cylinder 97; mixing the gas 101 introduced from the cylindrical tube 96 using the negative pressure generated at the center of the liquid swirling flow formed by the centrifugal force created in the injection with the liquid 102 near the liquid injection port of the through-slits 103 (or the through-holes); and discharging the gas-liquid swirling flow obtained by mixing of the liquid 102 and the gas 101 through the inner wall surface of the inner cylinder 97 from an open end 98 functioning as a gas-liquid discharge outlet.

In addition, the microbubble generation device according to this embodiment can adjust the temperature of the liquid in which the microbubble generation device is immersed by the following method. Specifically, the method for generating microbubbles fundamentally comprises: injecting and introducing the pressurized liquid into the gas-liquid swirling chamber 99 inside the inner cylinder 97 through the through-slits 103 (or the through- holes) formed in the inner cylinder 97 by supplying the pressurized liquid from the liquid inlet of the liquid supply cylinder 94 in FIG. 16, introducing a warm air having a temperature higher than that of the liquid before the microbubble generation device 93 is immersed or a cold air having a lower temperature into the gas-liquid swirling chamber 99 inside the inner cylinder 97 from the outside; mixing the warm air or the cold air introduced from the cylindrical tube 96 using the negative pressure generated at the center of the liquid swirling flow formed by the centrifugal force created in the injection with the liquid 102 near the liquid injection port of the through-slits 103 (or the through-holes); and discharging the gas-liquid swirling flow obtained by mixing of the liquid 102 and the gas 101 through the inner wall surface of the inner cylinder 97 from an open end 98 functioning as a gas-liquid discharge outlet.

According to this method, for example, by introducing the warm air from an air conditioner or the hot air from a heater through cylindrical tube, the warm gas is sent into the liquid in which the microbubble generation device according to the present invention is immersed. Thereby the temperature of the entire liquid can be raised without using a heater for heating. Moreover, when the temperature rises too much, it can respond easily only by stopping the operation of a microbubble generation device. When it is conversely desired to lower the temperature of the liquid, the temperature of the entire liquid can be lowered without cooling the entire room by introducing the cool air from an air conditioner or outside air. This method can easily adjust the temperature of the liquid by generating bubbles from the inside thereof, when the temperature of a large amount of water or liquid stored in a large-capacity container, such as aquaculture water or food liquid, is adjusted appropriately. Therefore, an unprecedented energy saving effect can be obtained.

### Eighth Embodiment

FIG. 19 is a cross sectional view showing an oil-water separation apparatus having the microbubble generation device according to the present invention. An oil-water separation apparatus 121 shown in FIG. 19 fundamentally comprises: a microbubble generation device 122 having the same configuration and structure as the seventh embodiment; an oil and water mixture separation tank 123 having a microbubble generation device 122 at the bottom and used for injecting and separating the oil and water mixture; and a pump 125 for supplying or circulating a part of the oil and water mixture, which is injected into the oil and water mixture separation tank 123, to a liquid supply cylinder 124 which the microbubble generation device 122 has. In the pipes between the oil and water mixture separation tank 123 and the pump 125, and between the pump 125 and the liquid supply cylinder 124, regulating valves 126 for adjusting a liquid volume are arranged as 126a and 126b, respectively.

Moreover, the oil-water separation apparatus 121 according to this embodiment may be equipped with a water storage tank 127 for storing the pure water containing no oil separately from an oil-water mixture liquid. The pure water is supplied from the water storage tank 127 to the liquid supply cylinder 124, and the pure water is introduced from the bottom of the oil and water mixture separation tank 123 together with the bubbles generated by the microbubble generation device 122, thereby the oil-water separation can be accelerated than the method for circulating only the oil and water mixture. This is because the introduction of the pure water increases the ratio of water in the oil and water mixture present at the bottom of the oil and water mixture separation tank 123 and in the lower prat thereof, and thereby promotes separation of the oil phase and the water phase. When the water storage tank 127 is also equipped, a pump 128 and regulating valves 129 for supplying the pure water are arranged as 129a and 129b between the water storage tank 127 and the liquid supply cylinder 124, respectively.

An operation principle of the oil-water separation apparatus shown in FIG. 19 will be described. The mechanism by which air bubbles promote the separation of dispersoids (oil colloidal particles) in the medium (water) is attributed to a main effect of increasing the buoyancy of oil colloidal or impurity particles, which is obtained by contacting the particles dispersed in the water and adsorbing them in the process of rising bubbles in the water. In this case, if the particle diameter of the bubbles is large, the rising speed of the bubbles is excessive, so that the oil colloid particles or impurity particles are not sufficiently adsorbed, and separation does not easily proceed. Therefore, it is necessary to generate microbubbles having a small particle size in the oil and water mixture.

The microbubble generation device 122 used in the oil-water separation apparatus 121 according to the present embodiment has an effect that a large amount of microbubbles can be generated. Therefore, the microbubble generation device122 is very effective for efficiently performing the oil and water separation. Furthermore, the fine bubble generation device 122 operates based on a simple mechanism in which bubbles are generated using formation of vortexes due to the generation of the swirling flow. In addition, the introduction of gas from outside can be performed only by attaching the cylindrical tube 130, so that it is not necessary to use a high-pressure air pump for sending the gas necessary for generating bubbles. If the gas is sent out by a high-pressure air pump, the high-pressure air pump must always be operated to prevent backflow even when the apparatus is stopped, resulting in a poor handling and maintenance.

Thus, since the oil-water separator 121 of this embodiment has a simple structure, it is excellent in a handling property and an operability, resulting in an improved durability. In addition, even if a situation occurs in which the device is replaced due to a malfunction or a natural disaster, the replacement work is easy and the maintainability is excellent.

FIG. 19 shows an oil phase 131 in a state where only the oil phase is separated from the oil and water mixture by operating the oil-water separation apparatus 121 and floats on the upper surface of the oil and water mixture. Since the floated oil phase 131 needs to be individually recovered and removed from the oil and water mixture separation tank 123. In the present embodiment, it is therefore preferable to have means for individually collecting the oil phase 131.

Examples of the means for individually collecting the oil phase 131 include a vacuum car and a vacuum suction device for sucking and collecting the oil phase 131, or an oil adsorbing material conventionally used. As the oil adsorbent, a naturally derived oil adsorbent having a known flaky or granular shape can be used. As other methods, for example, the oil phase 131 may be individually collected by a method as shown in FIG. 20.

FIGS. 20A and 20B are cross-sectional views showing a modified example of the oil-water separation apparatus according to the present invention. An oil-water separation apparatus 132 shown in FIGS. 20A and 20B is basically the same in structure and structure as the oil-water separation apparatus 121 shown in FIG. 19. However, the oil-water separation apparatus 132 comprises; a discharge port 133 for taking out only the oil phase 131 floating in a top thereof, an oil storage tank 134 for removing the oil phase 131 flowing out from the discharge outlet 133; a pipe connecting the discharge outlet 133 and the oil storage tank 134; and a regulating valve 135 added in the middle of the pipe. These constituents are different from the oil-water separation apparatus 121.

A method for individually collecting the oil phase 131 will be described using FIGS. 20A and 20B. FIGS. 20A and 20B illustrates a state before collection and that in the middle of collection of the floated oil phase 131, respectively. First, by continuing the operation of the microbubble generation device 132, the oil separated from the oil and water mixture gradually floats above the oil and water mixture separation tank 123, and finally the oil phase 131 is formed at the top. (see FIG. 20A). Next, the regulating valve 126 b is closed, and then pure water is supplied from the water storage tank 127 to the inside of a liquid supply cylinder 124 located at the bottom of the microbubble generation device 122. Then, not only bubbles are continuously generated by the introduction of the pure water, but also the liquid level (the position of the liquid level) of the oil and water mixture rises, and then the oil phase 131 moves to the position of the discharge outlet 133. At that time the discharging of the oil phase 131 starts, and the oil phase 131 flows into the oil storage tank 134 (see FIG. 20B). If the water existing under the oil phase 131 is also discharged at that time, the oil phase 131 can be almost completely removed. Then, after confirming that the oil phase 131 has been completely removed from the top of the oil and water mixture separation tank 123, the supply of pure water from the water storage tank 127 is stopped, or a liquid level is lowered by flowing a part of the oil and water mixture, most of whose components are converted to water by the separation treatment, backward to the water storage tank 127 by the pump 128. The water returned to the water storage tank 127 by the backflow can be reused as a part of the pure water used for the next oil and water separation treatment.

As described above, using the oil-water separation apparatus 132 according to this embodiment, only the oil phase 131 can be easily taken out from the tank 123 to the outside by moving the liquid level of the oil and water mixture separated in the oil and water mixture separation tank 123 up and down. Therefore, compared with the case where a vacuum car, a vacuum suction device, an oil adsorbing material, or the like is used, the oil phase 131 can be easily collected, resulting in a reduction of the processing cost.

As described above, the microbubble generation device according to the present invention uses the simple mechanism of generating the swirl flow, and has the simpler configuration and structure than conventional swirl flow microbubble generation devices. Thereby, a large amount of microbubbles can be generated over a long period of time, resulting in excellent properties in handling, operability and durability. Therefore, when the microbubble generation device according to the present invention is applied to the shower apparatus, not only high cleaning efficiency but also an effect of improving the skin massaging effect and blood circulation can be obtained. In addition, when applied to the transportation and farming of living organisms, water purification, tap water, river water, ponds, lakes, dams, etc. for water quality purification and resuscitation of the water environment, the microbubble generation device according to the present invention greatly contributes to the maintenance and growth of living organisms and environmental conservation. Furthermore, when the swirl flow microbubble generation device according to the present invention is applied as the component of the oil-water separation apparatus, not only the efficient oil and water separation performance is maintained for a long period of time, but also the oil-water separation apparatus having excellent operability and durability, and high versatility can be obtained due to the simple structure and configuration.

### INDUSTRIAL APPLICABILITY

The microbubble generator according to the present invention has an extremely high usefulness, because the device can be applied to various uses such as the shower apparatus, the air inflation device for water purification and water environment resuscitation, and the oil and water separation apparatus.

### EXPLANATION OF SYMBOLS

1,12,14,30,46,62,93,105,107,122 . . . Microbubble generation device
2,15,34,49 ... Gas supply cylinder
3, 26, 39, 54, 65 . . . Gas inlet
4, 22, 40, 55, 70, 99, 114 . . . Gas-liquid swirling chamber
5 . . . Cylindrical or conical cylinder
6, 31, 47, 94, 117, 124 . . . Liquid supply cylinder
7, 19, 38, 53, 63, 118 . . . Liquid inlet
8 . . . Gas-liquid swirling flow
9, 61 . . . Cylindrical through-hole
10, 17, 35, 50, 66, 119 . . . Gas-liquid discharge outlet
11 . . . Small swirling vortex
13, 27, 45, 77, 80 . . . Recessed part
16, 32, 48, 64, 95, 108 . . . Outer cylinder container
18, 36, 51, 67, 78, 85, 88, 97, 109 . . . inner cylinder
20, 83, 90, 100, 110 . . . closed end

### 21, 69, 82, 89, 98 . . . Open end

### 23, 42, 79, 86, 87, 103 . . . Through-slit

### 24, 43, 57 . . . Gap

### 25, 44, 101, 113 . . . Gas

28, 81, 120 . . . Small vortex branch wall
29, 84, 92 . . . vortex
33 . . . Air holder
37, 52, 68, 102, 116 . . . liquid

### 41 . . . Vent

### 56, 71, 91, 115 . . . Through-hole

### 58, 59, 74, 75 . . . Air

### 60 . . . Valve

### 72a, 72b . . . Passage

### 73 . . . O-ring

76 . . . Small hole
96, 111, 130 . . . Cylindrical tube

### 104 . . . Bubble

106 . . . Gas flow rate adjusting valve
112 . . . Gas introduction through-hole
121,132 . . . Oil-water separation apparatus
123 . . . Oil and water mixture separation tank

### 125,128 . . . Pump

126, 129, 135 . . . Regulating valve
127 . . . Water storage tank
131 . . . Oil phase
133 . . . discharge outlet
134 . . . Oil storage tank

1. A microbubble generation device comprising: a cylindrical or conical cylinder having a gas-liquid swirling chamber therein for creating a space where a gas-liquid can swirl;
a gas-liquid discharge outlet formed on one side of the cylindrical or conical cylinder for discharging a gas-liquid mixture obtained by mixing a gas and a liquid in the gas-liquid swirling chamber; a liquid supply cylinder having a liquid inlet for introducing the liquid into the gas-liquid swirling chamber; and the gas supply cylinder having a gas inlet for introducing the gas into the gas-liquid swirling chamber,
wherein the gas-liquid discharge outlet has a plurality of through-holes or small recessed parts for branching and changing a large swirling vortex formed by the gas-liquid swirling chamber into smaller swirling vortexes on a liquid discharge side of the cylindrical or conical cylinder having a gas-liquid swirling chamber therein,
wherein the through-holes have a cylindrical shape and a small cross sectional circle diameter, being formed as the gas-liquid discharge outlet on an end wall surface closed on one side of the cylindrical or conical cylinder having the gas-liquid swirling chamber therein,
wherein the small recessed parts have a circular cross section and a circumferential length of a semicircle or more, being formed from the gas-liquid discharge outlet to the middle along a longitudinal direction of the inner wall of the cylindrical or conical cylinder toward the inside of the cylindrical or conical cylinder on the circumferential surface of the end inner wall opened at one side of the cylindrical or conical cylinder having the gas-liquid swirling chamber.

2. The microbubble generation device according to claim 1,
wherein a circular diameter of a circular cross-sectional shape of the cylindrical through-holes or the small recessed parts is less than a half of the inner wall cross-sectional diameter of the cylindrical or conical cylinder having the gas-liquid swirling chamber therein, and has 10 mm or less as the absolute value.

3. The microbubble generation device according to claim 2,
wherein each of the plurality of cylindrical through-holes has the same diameter in the circular cross-sectional shape, and is formed point-symmetrically with respect to a center of an end wall surface that is closed on one side of the cylindrical or conical cylinder having the gas-liquid swirling chamber therein,
wherein each of the plurality of small recessed parts has the same diameter in the circular cross sectional shape, and is formed continuously in the state adjacent to each other on the circumferential surface of the inner wall of one end of the cylindrical or conical cylinder having the gas-liquid swirling chamber therein.

4. (canceled)

5. The microbubble generation device according to claim 1, the device comprising:
an inner cylinder composed of the cylindrical or conical cylinder having the gas-liquid swirling chamber therein for creating the space where the gas-liquid can swirl; a cylindrical or conical outer cylinder container that forms a double cylindrical structure together with the inner cylinder inserted therein; and the supply cylinder having the liquid inlet for introducing the liquid into the outer cylinder container,
wherein the inner cylinder comprises: an end closed at the liquid supply cylinder side; an end opposite to the liquid supply cylinder side, which has an opening for introducing the gas, provided as the gas inlet for introducing gas into the gas-liquid swirling chamber, and the plurality of cylindrical through-holes or the plurality of small recessed parts with a circular cross section and a circumferential length of a semicircle or more, provided as the gas-liquid discharge outlet for discharging the gas-liquid from the gas-liquid swirling chamber, wherein the small recessed parts are formed up to the middle along the longitudinal direction of the inner wall of the cylindrical or conical cylinder from the gas-liquid discharge outlet toward the inside of the cylindrical or conical cylinder on the circumferential surface of the end inner wall opened at one side opposite to the liquid supply cylinder side; and one or more through-slits or through-holes that are formed from one end on the liquid supply cylinder side to the middle along a longitudinal direction of the inner cylinder,
wherein the inner cylinder is integrated with the outer cylinder container in such a way that a gap for introducing the liquid is formed between the inner cylinder outer wall of the part where the through-slits or the through-holes are formed and the inner wall of the outer cylinder container, and
wherein microbubbles are generated using the gas-liquid swirling flow created by injecting and introducing the liquid which is supplied through the through-slits or through-holes from the liquid introduction inlet of the liquid supply cylinder into the gas-liquid swirling chamber equipped inside the inner cylinder.

6. The microbubble generation device according to claim 1, the device comprising:
an inner cylinder composed of the cylindrical or conical cylinder having the gas-liquid swirling chamber therein for creating the space where the gas-liquid can swirl; the cylindrical or conical outer cylinder container that forms a double cylindrical structure together with the inner cylinder inserted therein; and the liquid supply cylinder having the liquid inlet for introducing liquid into the outer cylinder container,
wherein the inner cylinder comprises: an opening end connected to the gas supply cylinder having a gas inlet on the liquid supply cylinder side, provided as the gas inlet for introducing gas into the gas-liquid swirling chamber; an end opposite to the liquid supply cylinder side, which has a plurality of cylindrical through-holes on the circumferential surface of the end inner wall closed thereat, or a plurality of small recessed parts with a circular cross section and a circumferential length of a semicircle or more on the circumferential surface of the end inner wall opened thereat, provided as the gas-liquid discharge outlet for discharging gas-liquid from the gas-liquid swirling chamber, wherein the small recessed parts are formed up to the middle along the longitudinal direction of the inner wall of the cylinder from the gas-liquid discharge outlet toward the inside of the cylindrical or conical cylinder; and one or more through-slits or through-holes that are formed from one end on the liquid supply cylinder side to the middle along a longitudinal direction of the inner cylinder,
wherein the inner cylinder is integrated with the outer cylinder container in such a way that a gap for introducing the liquid is formed between the inner cylinder outer wall of the part where the through-slits or through-holes are formed and the inner wall of the outer cylinder container, and
wherein microbubbles are generated using the gas-liquid swirling flow created by injecting and introducing the liquid which is supplied through the through-slits or the through-holes from the liquid introduction inlet of the liquid supply cylinder into the gas-liquid swirling chamber equipped inside the inner cylinder.

7. The microbubble generation device according to claim 1, the device comprising:
an inner cylinder composed of the cylindrical or conical cylinder having the gas-liquid swirling chamber therein for creating the space where the gas-liquid can swirl; a cylindrical or conical outer cylinder container that forms a double cylindrical structure together with the inner cylinder inserted therein; and the liquid supply cylinder having the liquid inlet for introducing liquid into the outer cylinder container,
wherein the inner cylinder comprises: an opening end Connected to the gas supply cylinder having a gas inlet on the liquid supply cylinder side, provided as the gas inlet for introducing gas into the gas-liquid swirling chamber; an end opposite to the liquid supply cylinder side, which has a plurality of cylindrical through-holes on the circumferential surface of the end inner wall closed thereat, or a plurality of small recessed parts with a circular cross section and a circumferential length of a semicircle or more on the circumferential surface of the end inner wall opened thereat, provided as the gas-liquid discharge outlet for discharging the gas-liquid from the gas-liquid swirling chamber, wherein the small recessed parts are formed up to the middle along the longitudinal direction of the inner wall of the cylinder from the gas-liquid discharge outlet toward the inside of the cylindrical or conical cylinder; and one or more through-slits or through-holes that are formed from one end on the liquid supply cylinder side to the middle along a longitudinal direction of the inner cylinder,
wherein the inner cylinder is integrated with the outer cylinder container in such a way that a gap for introducing the liquid is formed between the inner cylinder outer wall of the part where the through slits or the through holes are formed and the inner wall of the outer cylinder container, and
wherein microbubbles are generated using the gas-liquid swirling flow created by injecting and introducing the liquid which is supplied through the through-slits or through-holes from the liquid introduction inlet of the liquid supply cylinder into the gas-liquid swirling chamber equipped inside the inner cylinder,

8. The microbubble generation device, according to claim 5,
wherein the through-slits or the through holes have an opening passage adjusting a jetting direction so that a position of P is included in a distance range of r/2 or less toward the center from the inner wall of the inner cylinder section on the vertical line, when an inner wall circular radius of the inner cylinder cross section is r, and a position of the inner wall section of the inner cylinder cross section where the injected liquid collides is P, wherein P is the position projected onto a line drawn with respect to the tangent fine of the inner wall circle parallel to the liquid injection direction.

9. (canceled)

10 (canceled)

11. The microbubble generation device according to claim 5,
wherein the microbubble generation device has a cylindrical tube for introducing the gas into the inner cylinder having the gas-liquid swirling chamber, being configured one end of the cylindrical tube to be the gas inlet.

12. A microbubble generation method (method for generating fine microbubbles) using the microbubble generation device according claim 15, the method comprising:
injecting and introducing a pressurized liquid supplied through the through-slits or through-holes formed in the inner cylinder from the liquid inlet of the liquid supply cylinder into the gas-liquid swirling chamber inside the cylinder by supplying a pressurized liquid from the liquid inlet of the liquid supply cylinder;
mixing the gas sucked from the gas inlet under a negative pressure generated at the center of the swirling flow of the liquid that is formed by a centrifugal force created when the liquid jet is introduced into the gas-liquid swirling chamber, with the liquid injected from a liquid injection port of the through-slits or the through-holes at the liquid injection port and in the vicinity thereof; and
discharging the gas-liquid swirling flow obtained by mixing of the liquid and the gas through the inner wall surface of the inner cylinder from the gas-liquid discharge outlet.

13. The microbubble generation method in a state of immersing the microbubble generation device according to claim 11 into a liquid, the method comprising:
injecting and introducing a pressurized liquid supplied through the through-slits or the through-holes formed in the inner cylinder from the liquid inlet of the liquid supply cylinder into the gas-liquid swirling chamber equipped inside the inner cylinder;
introducing the gas through the cylindrical tube from the outside into the gas-liquid swirling chamber equipped inside the inner cylinder; mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through-slits or the through-holes at the liquid injection port and in the vicinity thereof; and
discharging the gas-liquid swirling flow obtained by mixing of the liquid through the inner wall surface of the inner cylinder from the gas-liquid discharge outlet.

14. The microbubble generation method in a state of immersing the microbubble generation device of claim 11 into a liquid, the method comprising:
injecting and introducing a pressurized liquid supplied from the liquid inlet of the liquid supply cylinder through the through-slits or through-holes formed in the inner cylinder into the gas-liquid swirling chamber inside the cylinder tube;
introducing a warm air with a higher temperature or a cool air with a lower temperature than the liquid before immersion of the microbubble generating device through the cylindrical tube from the outside into the gas-liquid swirling chamber equipped inside the inner cylinder;
mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through slits or the through holes at the liquid injection port and in the vicinity thereof; and
discharging the gas-liquid swirling flow obtained by mixing of the liquid through the inner wall surface of the inner cylinder from the gas-liquid discharge outlet,
wherein a temperature in the liquid having the microbubble generation device immersed therein is adjusted by the warm air or the cool air.

15. A shower apparatus comprising the microbubble generating device according to claim 1,
wherein a water or a hot water is supplied from an opening located on the side opposite to the liquid introduction inlet in the liquid supply cylinder, and sprayed from the gas-liquid discharging outlet of the microbubble generation device in a state of containing microbubbles.

16. An oil-water separation apparatus comprising:
the microbubble generating device according to claim 11 arranged at a bottom of the oil-water separator;
an oil and water mixture separation tank for injecting an oil and water mixture; and
a pump for supplying or circulating a part of the oil and water mixture injected into the oil and water mixture separation tank to the liquid supply cylinder equipped in the microbubble generation device.

17. The microbubble generation device, according to claim 6,
wherein the through-slits or the through-holes have an opening passage adjusting a jetting direction so that a position of P is included in a distance range of r/2 or less toward the center from the inner wall of the inner cylinder section on the vertical line, when an inner wall circular radius of the inner cylinder cross section is r, and a position of the inner wall section of the inner cylinder cross section where the injected liquid collides is P, wherein P is the position projected onto a line drawn with respect to the tangent line of the inner wall circle parallel to the liquid injection direction.

18. The microbubble generation device, according to any of claim 7,
wherein the through-slits or the through-holes have an opening passage adjusting a jetting direction so that a position of P is included in a distance range of r/2 or less toward the center from the inner wall of the inner cylinder section on the vertical line, when an inner wall circular radius of the inner cylinder cross section is r, and a position of the inner wall section of the inner cylinder cross section where the injected liquid collides is P, wherein P is the position projected onto a line drawn with respect to the tangent line of the inner wall circle parallel to the liquid injection direction.

19. The microbubble generation device according to any of claim 7,
wherein the microbubble generation device has a cylindrical tube for introducing the gas into the inner cylinder having the gas-liquid swirling chamber, being configured one end of the cylindrical tube to be the gas inlet.

20. A microbubble generation method (method for generating fine microbubbles) using the microbubble generation device according to claim 6, the method comprising:
injecting and introducing a pressurized liquid supplied through the through-slits or through-holes formed in the inner cylinder from the liquid inlet of the liquid supply cylinder into the gas-liquid swirling chamber inside the cylinder by supplying a pressurized liquid from the liquid inlet of the liquid supply cylinder;
mixing the gas sucked from the gas inlet under a negative pressure generated at the center of the swirling flow of the liquid that is formed by a centrifugal force created when the liquid jet is introduced into the gas-liquid swirling chamber, with the liquid injected from a liquid injection port of the through-slits or the through-holes at the liquid injection port and in the vicinity thereof; and
discharging the gas-liquid swirling flow obtained by mixing of the liquid and the gas through the inner wall surface of the inner cylinder from the gas-liquid discharge outlet.

21. A microbubble generation method (method for generating fine microbubbles) using the microbubble generation device according to claim 7, the method comprising:
injecting and introducing a pressurized liquid supplied through the through-slits or through-holes formed in the inner cylinder from the liquid inlet of the liquid supply cylinder into the gas-liquid swirling chamber inside the cylinder by supplying a pressurized liquid from the liquid inlet of the liquid supply cylinder;
mixing the gas sucked from the gas inlet under a negative pressure generated at the center of the swirling flow of the liquid that is formed by a centrifugal force created when the liquid jet is introduced into the gas-liquid swirling chamber, with the liquid injected from a liquid injection port of the through-slits or the through-holes at the liquid injection port and in the vicinity thereof; and
discharging the gas-liquid swirling flow obtained by mixing of the liquid and the gas through the inner wall surface of the inner cylinder from the gas-liquid discharge outlet.

22. The microbubble generation method in a state of immersing the microbubble generation device according to claim 19 into a liquid, the method comprising:
injecting and introducing a pressurized liquid supplied through the through-slits or the through-holes formed in the inner cylinder from the liquid inlet of the liquid supply cylinder into the gas-liquid swirling chamber equipped inside the inner cylinder;
introducing the gas through the cylindrical tube from the outside into the gas-liquid swirling chamber equipped inside the inner cylinder; mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through-slits or the through-holes at the liquid injection port and in the vicinity thereof; and
discharging the gas-liquid swirling flow obtained by mixing of the liquid through the inner wall surface of the inner cylinder from the gas-liquid discharge outlet.

23. The microbubble generation method in a state of immersing the microbubble generation device of claim 19 into a liquid, the method comprising:
injecting and introducing a pressurized liquid supplied from the liquid inlet of the liquid supply cylinder through the through-slits or through-holes formed in the inner cylinder into the gas-liquid swirling chamber inside the cylinder tube;
introducing a warm air with a higher temperature or a cool air with a lower temperature than the liquid before immersion of the microbubble generating device through the cylindrical tube from the outside into the gas-liquid swirling chamber equipped inside the inner cylinder;
mixing the gas sucked from the cylindrical tube under a negative pressure generated at the center of the swirling flow of the liquid that is formed by a centrifugal force created when the liquid jet is introduced into the gas-liquid swirling chamber, with the liquid ejected from a liquid injection port of the through slits or the through holes at the liquid injection port and in the vicinity thereof; and
discharging the gas-liquid swirling flow obtained by mixing of the liquid through the inner wall surface of the inner cylinder from the gas-liquid discharge outlet,
wherein a temperature in the liquid having the microbubble generation device immersed therein is adjusted by the warm air or the cool air.

24. A shower apparatus comprising the microbubble generating device according to claim 5,
wherein a water or a hot water is supplied from an opening located on the side opposite to the liquid introduction inlet in the liquid supply cylinder, and sprayed from the gas-liquid discharging outlet of the microbubble generation device in a state of containing microbubbles.

25. A shower apparatus comprising the microbubble generating device according to claim 6,
wherein a water or a hot water is supplied from an opening located on the side opposite to the liquid introduction inlet in the liquid supply cylinder, and sprayed from the gas-liquid discharging outlet of the microbubble generation device in a state of containing microbubbles.

26. A shower apparatus comprising the microbubble generating device according to claim 7,
wherein a water or a hot water is supplied from an opening located on the side opposite to the liquid introduction inlet in the liquid supply cylinder, and sprayed from the gas-liquid discharging outlet of the microbubble generation device in a state of containing microbubbles.

27. An oil-water separation apparatus comprising:
the microbubble generating device according to claim 19 arranged at a bottom of the oil-water separator;
an oil and water mixture separation tank for injecting an oil and water mixture; and
a pump for supplying or circulating a part of the oil and water mixture injected into the oil and water mixture separation tank to the liquid supply cylinder equipped in the microbubble generation device.
